(19) United States
(12) Patent Application Publication
(10) Pub. No.: US 2020/0151528 A1
(43) Pub. Date: May 14, 2020

(54) PERSONALIZED PATTERN-BASED COMMODITY VIRTUAL CODE ASSIGNMENT METHOD AND SYSTEM

(71) Applicant: PPK (HAINAN) AI CO. LTD [CN/CN], Haikou (CN)

(72) Inventor: Mingfa CHEN, Haikou (CN)

(21) Appl. No.: 16/739,158

(22) Filed: Jan. 10, 2020

Related U.S. Application Data
(63) Continuation of application No. PCT/CN2018/093236, filed on Jun. 28, 2018.

(30) Foreign Application Priority Data
Jul. 13, 2017 (CN) 201710572258.2
Jul. 15, 2017 (CN) 201710578004.1
Jul. 19, 2017 (CN) 201710592830.1
Aug. 25, 2017 (CN) 201710743494.6
Aug. 28, 2017 (CN) 201710750358.X

(51) Int. Cl. G06K 19/06; H04N 1/00; G06K 1/12

(52) U.S. Cl. CPC G06K 19/06056; H04N 1/00249; G06K 1/121; H04N 1/0044; G06K 19/06037; H04N 1/00244

(57) ABSTRACT

A personalized pattern-based commodity virtual code assignment method and system, which assign commodity codes to commodities but not print out. The present invention prints a naturally formed, two-dimensional and random personalized feature pattern on each commodity with the traditional processes such as forme-based printing; collects personalized feature information and assigns commodity codes; and associates and stores the personalized feature information and the commodity codes into a preset database. The commodity code can be retrieved and acquired from the database by scanning the personalized feature pattern on a commodity with a client. With the present invention, code assignment can be conducted without a digital printer, so no digital printing process is required, and the code assignment cost can be reduced. With the method of printing personalized patterns and associating commodity codes, the present invention opens up another way to realize commodity code assignment and creates the code assignment of non-digital printers.

### TECHNICAL FIELD

The present invention belongs to the technical field of digital printing and particularly relates to a printing process and system assigning one unique variable code to each commodity with a traditional forme-based printing machine and process (i.e., non-digital printing process)—personalized pattern-based commodity virtual code assignment, method and system.

### BACKGROUND

The traditional printing machines are classified as relief printing press, gravure press, planographic press and silk screen press. Because the traditional printing process must use a forme to print figures and texts, the traditional printing belongs to forme-based printing. The printed figures and texts are transferred to substrates from the forme with ink, so the printed, figures and texts are all in the same key.

The digital printers are classified as ink-jet printer, laser imaging printer and laser engraving printer. The digital printers can complete fill color images at a time without plate making. Therefore, digital printing belongs to formeless printing. Digital printing can be performed from one piece and the contents differ from one another.

Two-dimensional code is a way to record data symbol information with a certain geometry and black and white patterns distributed on a plane (in the two-dimensional direction) according to a certain law, which cleverly exploits the concept of “0” and “1” bit streams constituting the internal logical basis for computer in coding, uses several geometric solids corresponding to the binary system to express the literal and numeric information, and automatically parses and reads the information by an image input device or photoelectric scanning device to realize automatic information processing: the two-dimensional code has some features in common with the bar code technology: each code system has its specific character set; each character has a definite width; a certain checking function is provided, and meanwhile, an automatic identification function for different lines of information and a graph rotation variation processing function, are also provided.

On Jun. 17, 2010, the Notice on Electronic Supervision of All Varieties of Essential Drugs issued by the State Food and Drug Administration (SFDA) stipulated that all successful bidders producing essential drug varieties must join the drug electronic supervision network before Mar. 31, 2011 and complete code assignment as specified. The coding rule of Chinese drug electronic supervision code is one code for one commodity, and each code have 20 digits, consisting of 2 country codes, 1 category code, 5 enterprise codes, 5 drug codes, 6 serial numbers and 1 check code. The Chinese drug electronic supervision code breaks through the traditional mechanism of one code for one category and achieves functional unification of government supervision, logistic application, merchant settlement and consumer inquiry. Consumers, merchants, enterprise management departments, government regulatory departments and other users can inquire the general name, dosage form, specification, manufacturer, production date, production batch number, expiration date and other information of a drug by means of special-purpose terminals such as SMS, phone, network and mobile APP.

The China's new version of Food Safety Law has been formally implemented since Oct. 1, 2015. The law specifies that the, state must establish a full food safety traceability system. On Apr. 1 2017, the State Food and Drug Administration issued “Provisions on Establishing Food Safety Traceability System for Food Production and Operation Enterprises”, which require that: to establish a food safety traceability system, food production and operation enterprises shall objectively, effectively and truly record and, save food quality safety information, realize consequent and reverse traceability for food quality safety, risk controllability, and product recall, cause identification and accountability in case of quality safety problems, and effectively implement the entity responsibility for quality safety to ensure food quality safety. In specific implementation, food production enterprises are required to assign a unique commodity code—variable code to each commodity including food, and to use the variable code such as commodity code as a traceability code.

In addition to that the national policies and legislations require to assign a code to a commodity, the commodity code also requires registering during commodity circulation and after-sales service processes. For example, when selling drugs to patients, a pharmacy needs to register the Chinese drug electronic supervision code (commodity code) of the drugs sold in order to trace to the source, recall the drugs and pursue responsibilities in the future. For another example, when some supermarkets with strict management sell commodities to consumers, registration is required for the commodity codes such as serial numbers on the commodities sold to facilitate return and exchange management, sales statistics management, logistics management, expiration time limit management, maintenance service management and other information management.

The current enterprise users print variable codes such as commodity code directly on commodity packages according to the current coding rules and standards (mostly in the form of bar codes). This process is commonly known as code assignment. For example, a Chinese patent application “a method for online code assignment and reading of variable information of commodity package and identification (CN106886809A)”. The patent application discloses an online code assignment method of commodity variable information, wherein the variable code spray printing unit is erected on a common printer, and simultaneously completes the traditional printing and the online code assignment of variable information. Therefore, variable codes in the form of bar codes must be printed with a digital printer.

General production technicians in the printing industry all know that digital printer equipment has large investment, low printing speed, high printing cost and unstable quality. According to statistics, the composite cost of printing a variable-code bar code (such as Chinese drug electronic supervision code) on commodity packages (such as medicine box) is currently about 1.5 cent (RMB). The cost is huge and unbearable for enterprises whose commodities (such as milk and drinks) have a particularly large number, a high printing production speed and a low selling price.

The number of commodities assigned with codes in China, including foods, drugs, cigarettes and daily necessities, has exceeded 3 trillion in 2016. It is accordingly calculated that the commodity code assignment cost paid by Chinese manufacturers for this purpose is about 50 billion yuan/year.

### SUMMARY

One purpose of the present invention is to provide a personalized pattern-based commodity virtual code assignment method—also called a personalized pattern-based two-dimensional code compiling, printing and parsing method or natural two-dimensional code application method to avoid printing variable codes such as commodity code with a digital printer so as to reduce the investment in commodity code assignment, equipment, increase the commodity code assignment speed, reduce the commodity code assignment cost and ensure the commodity code assignment quality.

The second purpose of the present invention is to provide a personalized pattern-based commodity code assignment system—also called a personalized pattern-based two-dimensional code compiling, printing and parsing system or a natural two-dimensional code system.

The personalized pattern-based commodity virtual, code assignment method of the present invention has the following technical solution.

A personalized pattern-based commodity virtual code assignment method is characterized by comprising:

\textcircled{1} Printing personalized feature pattern—

During production and manufacturing, setting a personalized feature area (3) on a commodity (2) and printing (naturally formed and) visible random dots or/and lines or/and planes in the personalized feature area (3) (for example, by a non-digital printer) to form at least one random personalized feature pattern (4) which is unique (i.e., no two are the same) within the predetermined number on each commodity (2);

The random dots or/and lines are either random textures (also called random spots) inherent in substrates such as paper or random ink marks or fine materials attached to the surfaces of substrates such as paper: either dark monochrome or dark colorful; either small dots and pieces or small color blocks and ink dots; either short lines or long line segments; either straight, line segments or curve segments; and can also be visible dots/lines such as character fragments of different geometries and with the widths less than 1 mm (for example, cut films printed with small characters); according to the basic knowledge of printing, the limit diameter/width of each visible dot/line is not less than 0.05 mm; and the diameter/width of each visible dot/line of the present invention is great than or equal to 0.05 mm;

\textcircled{2} Collecting personalized feature information—

During production and manufacturing, photographing (also called scanning) the personalized feature pattern (4) on the commodity (2) to obtain a random personalized feature image (20) which is unique within the predetermined number—i.e., personalized feature information; or/and, photographing (also called scanning) the personalized feature pattern (4) on the commodity (2), and according to the predetermined rule, parsing a random personalized feature code (5) of each commodity (2) which is unique within the predetermined number from the personalized feature pattern (4) or the personalized feature image (26)—i.e., personalized feature information; and photographing described here generally refers to various technical means of acquiring personalized feature information such as images or personalized feature codes (5), not limited to photographing and other current information collection methods;

\textcircled{3} Backing up the personalized feature information—

Backing up and storing the personalized, feature information such as photographed personalized feature images (20) or/and parsed personalized feature codes (5) (without associating other information) into the database (16) (including offline storage medium); or, assigning at least one unique commodity code (1) to each commodity (2), and associating and storing the commodity code (1) and the personalized feature information into the preset database (16) (such as real-time online cloud) instead of printing the commodity code (1) on the commodity (2); preferably, the commodity code (1) is split into at least two segments: a fixed code segment and a variable code segment, wherein the fixed code segment is printed in the personalized feature area (3) on the commodity (2), and the variable code segment is not printed (cannot be printed by a forme-based printing machine in fact) on the commodity (2), in other words, the commodity code (1) is not fully printed on the commodity (2), and only the local code segment is printed on the commodity (2);

\textcircled{4} Parsing and accessing the commodity code (1)—

When a user needs to user the commodity code (1), scanning the personalized feature area (3) on the commodity (2) and the personalized feature pattern (4) thereof with a client (7), parsing the personalized feature code (5) from the personalized, feature pattern (4) with the client (7) according to the predetermined rule, and directly using the personalized feature code (5) as the commodity code (1) of the scanned commodity (2), for example, as traceability code, Chinese drug electronic supervision code, logistics code and product serial number, specifically, associating the personalized feature codes (5) of a plurality of commodities (2) in the same packing unit for management on goods receipt and delivery; and the solution can be an offline solution, and the user can conduct data exchange with the server (6) for data check after obtaining the personalized feature code (5);

Or, networking the preset database (16) with the server (6) by the communication network (24); when a user needs to use the commodity code (1), scanning the personalized feature area (3) on the commodity (2) and the personalized feature pattern (4) and other identifiers therein with a client (7), and uploading the personalized feature information with the client (7); and after a server (6) receives the personalized feature information uploaded from the client (7), retrieving the associated commodity, code (1) from the preset database (16) according to the personalized feature information and feeding back to the client (7) for use by the user. The solution belongs to the online application solution. The, purpose of the replacement is to replace the unordered personalized feature code (5) of a non-standard structure with the ordered commodity code (1) of a standard structure so as to adapt to the current structure standard of the commodity code (1), not change the current commodity (2) purchase-sell-stock data management system and other application systems of the user, and respect the traditional commodity code (1) using habit of the user.

The above commodity code (1) is not really printed on the commodity (2), and is only associated with the personalized feature information of the commodity (2) and recorded into the preset database (16). Therefore, the commodity code (1) can be called virtual code assignment. In other words, the commodity code (1) of the present invention is not printed on the physical commodity (2) but bound to they personalized feature information of the commodity (2) and recorded into the preset database (16).

The specific technical solutions consisting of the above steps \textcircled{1}, \textcircled{2}, \textcircled{3} and \textcircled{4} are described as follows.

Solution 1:

\textcircled{1} Printing personalized feature patterns—

During production and manufacturing, setting a personalized feature area (3) on a commodity (2) and printing naturally formed and visible random dots or/and lines or/and planes in the personalized feature area (3) to form at least one random personalized feature pattern (4) which is unique within the predetermined number on each commodity (2);

\textcircled{2} Collecting personalized feature information—

During production and manufacturing, photographing the personalized feature pattern (4) on the commodity (2) to obtain a random personalized feature image (20) which is unique within the predetermined number;

\textcircled{3} Backing up the personalized feature information—

Backing up and storing the photographed personalized feature image (20) into the preset database (16) for various management purposes such as commodity (2) quality tracking;

\textcircled{4} Parsing and accessing the commodity code (1)—

When a user needs to user the commodity code (1), scanning the personalized feature pattern (4) on the commodity (2) with a client (7) parsing the personalized feature code (5) from the personalized feature pattern (4) with the client (7) according to the predetermined rule, and using the personalized feature code (5) as the commodity code (1) of each commodity (2), so as to carry out the relevant application according to the commodity code (1).

Solution 2:

\textcircled{1} Printing personalized feature patterns—

During production and manufacturing, setting a personalized feature area (3) on a commodity (2) and printing naturally formed and visible random dots or/and lines or/and planes in the personalized feature area (3) to form at least one, random personalized feature pattern (4) which is unique within the predetermined number on each commodity (2);

\textcircled{2} Collecting personalized feature information—

During production and manufacturing, photographing the personalized feature pattern (4) on the commodity (2) to obtain a random personalized feature image (20) which is unique within the predetermined number;

\textcircled{3} Backing up the personalized feature information—

Backing up and storing the photographed personalized feature image (20) into the preset database (16) as the personalized feature information, assigning at least one unique commodity code (1) to each commodity (2), and associating and storing the commodity code (1) into the preset database (16) instead of printing the commodity code (1) on the commodity (2);

\textcircled{4} Parsing and accessing the commodity code (1)—

When a user needs to use the commodity code (1), scanning the personalized feature pattern (4) on the commodity (2) with a client (7) to acquire the personalized feature image (20) as the personalized feature information; and retrieving the associated commodity code (1) from the preset database (16) according to the personalized feature information and feeding back to the client (7) for the user to carry out the relevant application.

Solution 3:

\textcircled{1} Printing personalized feature patterns—

During production and manufacturing, setting a personalized feature area (3) on a commodity (2) and printing naturally formed and visible random dots or/and lines or/and planes in the personalized feature area (3) to form at least one, random personalized feature pattern (4) which is unique within the predetermined number on each commodity (2);

\textcircled{2} Collecting personalized feature information—

During production and manufacturing, photographing the personalized feature pattern (4) on the commodity (2) to obtain the personalized feature image (20), and according to the predetermined rule, parsing a random personalized feature code (5) of each commodity (2) which is unique within the predetermined number from the personalized feature image (20);

\textcircled{3} Backing up the personalized feature information—

Backing up and storing the parsed personalized feature code (5) into the preset database (16) as the personalized feature information; and assigning at least one unique commodity code (1) to each commodity (2), and associating and storing the commodity code (1) and the personalized feature information into the preset database (16) instead of printing the commodity code (1) on the commodity (2);

\textcircled{4} Parsing and accessing the commodity code (1)—

When a user needs to use the commodity code (1), scanning the personalized feature pattern (4) on the commodity (2) with a client (7); parsing the personalized feature code (5) from the personalized feature pattern (4) according to the predetermined rule as the personalized feature information; and retrieving the associated commodity code (1) from the preset database (16) according to the personalized feature information and feeding back to the client (7) for the user to carry out the relevant application.

Solution 4:

\textcircled{1} Printing personalized feature patterns—

During production and manufacturing, setting a personalized feature area (3) on, a commodity (2) and printing naturally formed and visible random dots or/and lines or/and planes in the personalized feature area (3) to form at least one random personalized feature pattern (4) which is unique within the predetermined, number on each commodity (2);

\textcircled{2} Collecting personalized feature information—

During production and manufacturing, photographing the personalized feature pattern (4) on the commodity (2) to obtain the personalized feature image (20), and according to the predetermined rule, parsing a random personalized feature code (5) of each commodity (2) which is unique within the predetermined number from the personalized feature image (20);

\textcircled{3} Backing up the personalized feature information—

Backing up and storing the parsed personalized feature code (5) into the preset database (16) as the personalized feature information; and using the personalized feature code (5) as the commodity code (1) of the scanned commodity (2) or as a part of the commodity code (1), and associating and storing the personalized feature code (5) and the other information of the commodity (2) into the preset database (16);

\textcircled{4} Parsing and accessing the commodity code (1)—

When a user needs to use the commodity code (1), scanning the personalized feature pattern (4) on the commodity (2) with a client (7), parsing the personalized feature code (5) from the personalized feature pattern (4) according to the predetermined rule, and using the personalized feature code (5) as the commodity code (1) of the scanned commodity (2), so as to carry out the relevant application according to the commodity code (1).

Solution 5:

\textcircled{1} Printing personalized feature patterns—

During production and manufacturing, setting a personalized feature area (3) on a commodity (2) and printing naturally formed and visible random dots or/and lines or/and planes in the personalized feature area (3) to form at least one, random personalized feature pattern (4) which is unique within the predetermined number on each commodity (2);

\textcircled{2} Collecting personalized feature information—

Photographing the personalized feature pattern (4) on the commodity (2) to obtain a random personalized feature image (20) which is unique within the predetermined number; and photographing the personalized feature pattern (4) on the commodity (2) to obtain the personalized feature image (20), and according to the predetermined rule, parsing a random personalized feature code (5) of the scanned commodity (2) which is unique within the predetermined number from the personalized feature image (20);

\textcircled{3} Backing up the personalized feature information—

Backing up and storing the photographed personalized feature image (20) and the parsed personalized feature code (5) into the preset database (16) as the personalized feature information; and assigning at least one unique commodity code (1) to each commodity (2), and associating and storing the commodity code (1) and the personalized feature information into the preset database (16) instead of printing the commodity code (1) on the commodity (2);

\textcircled{4} Parsing and accessing the commodity code (1)—

When a user needs to use the commodity code (1), scanning the personalized feature pattern (4) on the commodity (2) with a client (7); parsing the personalized feature code (5) from the personalized feature pattern (4) according to the predetermined rule, and using the personalized feature pattern (4) and the personalized feature code (5) as the personalized feature information; and retrieving the associated commodity code (1) from the preset database (16) according to the personalized feature information and feeding back to the client (7) for the user to carry out the relevant application.

In this way, consumers, distributors, market regulatory departments, market management personnel, product tracers, award winners and other users can acquire the commodity code (1) to carry out the relevant application by scanning the personalized feature area (3) on the commodity (2) and the personalized feature pattern (4) and other identifiers therein with a client (7). In this way, the commodity codes (1) scanned (exactly, most of which are retrieved and inquired from the preset database (16)) are commodity codes (1) that can be compatible with various current computer application systems, such as traceability code, logistics code, redeem code, point code and marketing code which conform to the current coding structure and standard.

As described above, some personalized feature codes (5) can be parsed based on the personalized feature pattern (4) on each commodity (2). To ensure the uniqueness of the personalized feature codes (5) and avoid number repetition with the personalized feature codes (5) of the other commodities (2) in the same group, the area, complexity and randomness of the personalized feature pattern (4) are needed to be maximized in practice. In this way, some parsed personalized feature codes (5) have extremely verbose digits, do not have sequentiality, standard structure or visualizability, are not convenient for manual input, manual error correction, consumer reading, copying and recording, or storage, and do not conform to the current coding rule and standard. Subject to scanning angle, light intensity, pixel of scanning cellphone and other factors, the personalized feature codes (5) of the same commodity (2) parsed by multiple scans are inconsistent. These disadvantages cause the personalized feature codes (5) to be difficult to use directly as the commodity code (1) in production, circulation and marketing management. Therefore, the present invention assigns the commodity cod (1) which corresponds to the commodity (2) and conforms to the current coding rule and structure standard for traceability code, etc. to the commodity (2) in the cloud (the cloud described in this document comprises a part of the server (6) or non-server (6) network), and feeds>back the commodity code (1) which is short, standard in structure, convenient for use and absolutely consistent in multiple scanning and retrieval results to the user so as to overcome the above disadvantages of the personalized feature code (5).

The book “Digital Anti-Counterfeiting Technology” (Book Number 9787506626910) published by China Standards Press in April 2002 introduces a coding rule and structure standard for the current commodity code (1): commodity code (1) structure=industry code+area code+enterprise code+product number+product serial number+random code+area control code. It can be seen that a commonly used commodity code (1) is composed of a fixed code segment and a variable code segment, wherein industry code+area code+enterprise code+product numbe+area control code constitute the fixed code segment, product serial number+random code constitute the variable code segment, which are short, standard in structure, conventional in nature, clear at a glance, and easy to use.

Preferably, the personalized pattern-based commodity virtual code assignment method comprises at least one of the following features.

\textcircled{1} Naturally formed random dots or/and lines or/and planes are printed in the personalized feature area (3) with the forme-based printing process or spraying process to form, the personalized feature pattern (4), and the formed personalized feature pattern (4) is dried and cured to be stable and unchanged; and the random dots or/and lines or/and planes mentioned here can be printed in a naturally formed (i.e., unartificial) method with various traditional equipment and processes such as, forme-based printing machine, spray painting equipment (also called sprayer), powder spreader, flocker, fiber printing machine and powder blower and without a digital printer. The specific printing method is described in embodiments of the present invention.

\textcircled{2} The predetermined number is n, and commodities (2) are divided into groups with n commodities in each group, wherein 100≤n≤100,000, or 100,000≤n≤1,000,000, or 1,000,000≤n≤10,000.000 or 10;000,000≤n≤1,00,000,000;

Each group of commodities (2) is assigned with at least one unique group number (9); the fixed code segment in the commodity code (1) is used as the group number (9) and printed in the personalized feature area (3) (preferably with the forme-based printing process); and the personalized feature information such as personalized feature image (20) or personalized feature code (5) of the same group of commodities (2), which is stored on the server (6), is assigned with the corresponding group number (9)—fixed code segment.

The purpose of the above step is to adapt to the traditional forme-based printing process and take account of the requirement that the personalized feature information such as personalized feature image (20 and personalized feature code (5) need to have uniqueness and fast retrieval. Therefore, the number n of each group of commodities (2) cannot be too large or too small. If n is too large, it is difficult to ensure the uniqueness of the personalized feature information such as personalized feature image (20) in the group and the retrieval speed is low. If n is too small, the group number (9) forme needs replacing frequently, which easily causes increase in production cost and reduction in production efficiency. From the perspective of coding structure, the group number (9) belongs to the fixed (constant) code segment of the commodity code (1) in the same group, and can be printed with the forme-based printing process just because it is a fixed code segment.

\textcircled{3} Randomly distributed colored fibers (13) are arranged in the personalized feature area (3), and the random distribution pattern of the colored fibers (13) forms at least one part of the personalized feature pattern (4) of each commodity (2);

or, random sawteeth (14) are naturally formed at the edges of the ink dots or/and lines or/and planes in the personalized feature area (3), and the sawteeth (14) form at least one part of the personalized feature pattern (4) of each commodity (2);

or, random textures (15) are naturally formed in the personalized feature area (3), and the random textures (15) form at least one part of the personalized feature pattern (4) of each commodity (2);

or, snow/ice flowers are naturally formed in the personalized feature area (3), and the snow/ice flowers form at least one part of the personalized feature pattern (4) of each commodity (2).

\textcircled{4} Image transcoding coordinates (10) or/and feature unit transcoding grids (11) conforming t the predetermined rule are printed on the personalized feature pattern (4), i.e., during the process of collecting personalized feature information, the personalized feature code (5) is parsed based on the image transcoding coordinates (10) or/and feature unit transcoding grids (11) of the personalized feature pattern (4) according to the predetermined rule, and during the process of parsing and accessing the commodity code (1), the personalized feature code (5) is parsed based on the image transcoding coordinates (10) or/and feature unit transcoding grids (11) of the personalized feature image (20) according to the predetermined rule; or, the personalized feature code (5) is parsed from the personalized feature image (20) with the virtual image transcoding coordinates (10) or/and feature unit transcoding grids (11), i.e., during the process of collecting personalized feature information, the personalized feature image (20) is assigned with, virtual image transcoding coordinates (10) or/and feature unit transcoding grids (11) and the personalized feature code (5) is parsed based on the personalized feature image (20) and, the virtual image transcoding coordinates (10) or/and feature unit transcoding grids (11) according to the predetermined rule, and during the process of parsing and accessing the commodity code (1), the personalized feature image (20) is assigned with virtual image transcoding coordinates (10) or/and feature unit transcoding grids (11), and the personalized feature code (5) is parsed from the personalized feature image (20) obtained based on the personalized feature pattern (4) and the virtual image transcoding coordinates (10) or/and feature unit transcoding grids (11) according to the predetermined rule.

\textcircled{5} X feature unit transcoding grids (11) are printed on the personalized feature pattern (4); personalized features of feature units in the feature unit transcoding grids OD are respectively expressed by different characters according to the predetermined rule to parse the corresponding personalized feature code (5) from the personalized feature image (20) according to the predetermined rule, i.e., during the process of collecting the personalized feature information and/or the process of parsing and accessing the commodity code (1), when the personalized feature code (5) is parsed based on the feature unit transcoding grids (11) of the personalized feature image (20) according to the predetermined rule, different personalized features of feature units in the feature unit transcoding grids (11) are respectively expressed by different characters to parse strings of corresponding personalized feature codes (5) from the personalized feature image (20) according to the predetermined rule.

\textcircled{6} The ratio of the code length of the commodity code (1) to the code length of the corresponding personalized feature code (5) is ≤0.5, or ≤0.3, or ≤0.1, or ≤0.01, i.e., during the process of collecting personalized feature information, when the random personalized feature code (5) of each commodity (2) which is unique within the predetermined number is pared from the personalized feature image (20) according to the predetermined rule, the personalized feature information is backed up, and when each commodity (2) is assigned with the commodity code (1), the ratio of the code length of the commodity code (1) to the code length of the corresponding personalized feature code (5) is kept ≤0.5, or ≤0.3, or ≤0.1, or ≤0.01.

\textcircled{7} The commodity code (1) and the personalized feature code (5) or/and personalized feature image (20) of the commodity (2) are associated and combined, and correspondingly stored according to the real production sequence of the commodities (2) on the assembly line, i.e., during the process of backing up the personalized feature information, the commodity code (1) of each commodity (2) is determined according to the real production sequence of the commodities (2) on the assembly line.

\textcircled{8} Positioning patterns or/and position detection patterns (19) are printed in the personalized feature area (3).

\textcircled{9} A graduated scale (22) is printed in the personalized feature area (3) or at the edge thereof for the parsing software to generate grid lines and feature unit transcoding grids (11) on the personalized feature image (20) in accordance with the graduated scale (22).

\textcircled{10} The personalized feature pattern (4) comprises a pattern consisting of randomly distributed thermochromic spots (21).

\textcircled{11} Multiple different personalized feature codes (5) are respectively parsed according to multiple predetermined rules (for example, different parsing precisions/different sampling positions) based on the same personalized feature pattern (4); the multiple different personalized feature codes (5) are associated with the same commodity code (1) and stored into the preset database (16); and in this way, number repetition can be avoided as far as possible. Of course, when a user scans the code, the corresponding commodity code (1) can be fed back to the user as long as one of multiple correct personalized feature codes (5) is parsed, i.e., during the process of collecting the personalized feature information, multiple different personalized feature codes (5) are respectively parsed from the same personalized feature pattern (4) according to multiple predetermined rules (for example, different parsing precisions/different sampling positions), and used as the personalized feature information; and during the process of backing up the personalized feature information, the multiple different personalized feature codes (5) are associated with the same commodity code (1) as the personalized feature information and stored into the preset database (16).

\textcircled{12} Multiple personalized feature codes (5) are respectively parsed according to multiple different predetermined rules based on the same personalized feature image (20); and after the same commodity code (1) is retrieved according to the multiple personalized feature codes (5), the commodity code (1) is fed hack to the client (7); and in this way, the scan code misreading rate can be educed, and the accuracy rate of acquiring the commodity code (1) by scanning the code can be increased, i.e., during the process of collecting the personalized feature information, multiple different personalized feature codes (5) are respectively parsed from the same personalized feature pattern (4) according to multiple predetermined rules, and used as the personalized feature information, and during the process of parsing and accessing the commodity code (1), after the personalized feature pattern (4) on the commodity (2) is scanned to obtain the same personalized feature image (20) multiple personalized feature codes (5) are respectively parsed according to multiple different predetermined rules, and used as the personalized feature information; and then, the commodity codes (1) are respectively retrieved from the preset database (16) according to the multiple personalized feature codes (5) used as the personalized feature information, and the same commodity codes (1) of the multiple obtained commodity codes (1) are fed back as the reference commodity code (1).

\textcircled{13} Multiple personalized feature patterns (4) are arranged in the same personalized feature area (3) on, the same commodity (2); multiple personalized feature codes (5) are respectively, parsed; the multiple personalized feature codes (5) are assigned to the same commodity code (1); when the multiple commodity codes (1) retrieved according to the multiple personalized feature codes (5) have the same commodity codes (1), the same commodity codes (1) are fed back to the client (7), i.e., during the process of printing the personalized feature patterns, multiple personalized feature patterns (4) are formed in the same personalized feature area (3) on the same commodity (2); during the process of collecting the personalized feature information, multiple personalized feature images (20) are obtained, personalized feature codes (5) are parsed from the multiple personalized feature images (20) respectively according to the predetermined rule, and the multiple personalized feature codes (5) are all used as the personalized feature information; during the process>of backing up the personalized feature information, the assigned commodity code (1) is respectively associated with the multiple personalized feature codes (5) used as the personalized feature information and stored into the preset database (18); during the process of parsing, and accessing the commodity code (1), after multiple personalized feature patterns (4) on the commodity (2) are scanned to obtain multiple personalized feature images (20), multiple personalized feature codes (5) are respectively parsed according to the predetermined rule, and used as the personalized feature information; and then, the commodity codes (1) are respectively retrieved from the preset database (16) according to the multiple personalized feature codes (5) used as the personalized feature information, and the same commodity codes (1) of the multiple obtained commodity codes (1) are fed back as the reference commodity code (1).

\textcircled{14} The same personalized feature image (20) is assigned with virtual feature unit transcoding grids (11) of different sizes, and multiple critical personalized feature codes (5) are parsed according to the predetermined rule; the multiple critical personalized feature codes (5) are assigned to the same commodity code (1); and after the commodity code (1) is retrieved according to any of the multiple critical personalized feature codes (5), the commodity code (1) is fed back to the client (7), i.e., during the process of collecting the personalized feature information, after the personalized feature pattern (4) on the commodity (2) is photographed to obtain the personalized feature image (20), the same personalized feature image (20) is assigned with virtual grid lines of different widths, multiple critical personalized feature codes (5) are parsed respectively based on the different virtual grid lines according to the predetermined rule; during the process of backing up the personalized feature information, the multiple critical personalized feature codes (5) are assigned to the same commodity code (1); and during the process of parsing and accessing the commodity code (1), when the personalized feature pattern (4) on the commodity (2) is scanned, virtual grid lines of the corresponding width are assigned to the personalized feature pattern (4), at least one critical personalized feature code (5) is parsed based on the virtual grid lines according to the predetermined rule to be used as the personalized feature information, and the associated commodity code (1) is retrieved from the preset database (16) according to the personalized feature information.

\textcircled{15} A commodity bar code (18) is arranged in the personalized feature area (3) on the commodity (2), the personalized feature pattern (4) on the commodity (2) is scanned, and the personalized feature code (5) of the scanned commodity (2) is parsed according to the predetermined rule; and the corresponding commodity code (1) is retrieved from the preset database (16) according to the personalized feature code (5). In the technical, solution, during the process of collecting personalized feature information and the process of parsing and accessing the commodity code (1), the personalized feature code (5) parsed based on the personalized feature image (20) or personalized feature pattern (4) includes data obtained based on the commodity bar code (18).

\textcircled{16} When the personalized feature image (20) is parsed at a certain parsing precision and the personalized feature code (5) is found to have duplicate numbers, another predetermined rule is enabled to parse the personalized feature image (20) at a higher parsing precision, and another parsed personalized feature code (5) is backed up into the preset database (16) as a check code, i.e., during the process of collecting the personalized feature information, one personalized feature code (5) is parsed from the personalized feature image (20) according to a predetermined rule-, during the process of backing up the personalized feature information, a step of detecting whether number repetition exists in the personalized feature code (5) is also included, and if the number repetition of the personalized feature code (5) is detected, the process of collecting the personalized feature information is re-implemented, and another personalized feature code (5) is parsed from the personalized feature image (20) according to another predetermined rule and backed up into the preset database (16) to be used as the check code corresponding to the first personalized feature code (5); and during the process of parsing and accessing the commodity code (1), after the first personalized feature code (5) is obtained, when the associated commodity code (1) is retrieved from the preset database (16) according to the personalized feature information of the first personalized feature code (5), the second personalized feature code (5) can be retrieved and fed back as required.

In this way, codes can be scanned for use according to the above multiple predetermined rule processing flows.

\textcircled{17} When the personalized feature area (3) containing the group number (9) is scanned and parsed on the client (7) and the group number (9) is parsed, a sound/light prompt is sent to inform the user of successful scanning; and the scanned personalized feature image (20) is reserved. The advantage of the setting is that even if the network speed is low, and the client (7) has not received the feedback commodity code (1) from the server (6), the scanning experience is not affected; and as long as the client (7) receives the feedback commodity code (1) from the server (6) at a later time, this is acceptable for users, i.e., during the process of parsing and accessing the commodity code (1), the client (7) is used to scan the personalized feature pattern (4) on the commodity (2) and parse the personalized feature code (5) according to the predetermined rule, a step of judging whether the personalized feature code (5) includes the group number (9) is also included, and if the judged result is positive, the sound/light device of the client (7) is triggered to send a sound/light prompt. It can be understood that, in order to be able to judge whether the group number (9) is included, the client (7) can make a judgment based on the field feature, field length and field characteristic of the personalized feature code (5), or a list of group numbers (9) can be built in to judge whether the group number (9) is included by comparing all or at least one part of the personalized feature code (5) with the group number (9) in the list.

\textcircled{18} When the personalized feature information is collected and the latter personalized feature code (5) and another preceding personalized feature code (5) within the same group number have duplicate numbers, the personalized feature image (20) corresponding to the (preceding or/and latter)personalized feature code (5) is added to the preset database (16) to be used as the differentiating feature information when the users parses and accesses the commodity code (1), i.e., during the process of backing up the personalized feature information, a step of detecting whether number repetition exists in the personalized feature code (5) is also included, and if the number repetition of the personalized feature code (5) is detected, the personalized feature image (20) obtained during the process of collecting the personalized feature information is backed up into the preset database (16) and associated with the personalized feature code (5); and during the process, of parsing and accessing the commodity code (1), when the associated commodity code (1) is retrieved from the preset database (16) according to the personalized feature code (5) used as the personalized feature information, the personalized feature image (20) associated with the personalized feature code (5) can be retrieved to be used as the differentiating feature information for exchange.

\textcircled{19} The client (7) is a smart, phone, or a smart phone or other terminal equipment installed with parsing software executing the predetermined rule.

\textcircled{20} The fixed code segment of the commodity code (1) is not printed on the commodity (2).

The feature unit transcoding grids (11) of the present invention are a marker used to convert the personalized features of the feature units to code information. The feature unit transcoding grids (11) are preferably square, and of course, can be in any other suitable shape such as circle, rectangle, triangle and honeycomb. The number of the feature unit transcoding grids (11) in the personalized feature area (3) and the area size of a single feature unit transcoding grid (11) both affect the uniqueness of the personalized feature code (5). For the feature unit transcoding grids (11) in the personalized feature area (3), the smaller the area is, the larger the number is, the higher the parsing precision is, the more the number repetition of the personalized feature code (5) can be avoided. To facilitate using the current mainstream smart phones owned by consumers as clients (7), the minimum size of the feature unit transcoding grid (11) can be applied to the resolution of smart phone camera lens. Research shows that only smart phones with the resolution of lens greater than 8 megapixels can clearly photograph feature units with an area greater than 0.05 mm×0.05 mm. In other words, the area s of each feature unit transcoding grid (11) must be greater than or equal to 0.05 mm×0.05 mm. In other words again, to adapt to the current smart phones with the resolution of lens greater than 8 megapixels, the highest parsing precision of the predetermined rule in the present invention can be: s=0.05 mm×0.05 mm.

Preferably, the personalized pattern-based commodity virtual code assignment method is characterized by comprising at least one of the following.

\textcircled{1} To avoid number repetition to the maximum extent and ensure the uniqueness of the personalized feature code (5), the predetermined number is n, the personalized feature pattern (4) or the personalized feature image (20) is divided into X feature unit transcoding grids (11), and the predetermined number n of each group of commodities (2) is less than or equal to 2x/100,000;

or, the predetermined number n of each group of commodities (2) is less than or equal to 2x/1,000,000;

or, the predetermined number n of each group of commodities (2) is less than or equal to 2x/10,000,000;

or, the number repetition rate of the personalized feature code (5) within the same group number (9) is less than 1/100,000.

This is because the personalized feature code (5) of the present invention is taken from the personalized feature pattern (4), and the personalized feature pattern (4) is naturally formed, two similar or even identical patterns will inevitably appear, which will cause two identical personalized feature codes (5) to inevitably appear, i.e., number repetition will inevitably appear. To avoid serious consequences caused by this problem, the assigned number of the commodities (2) with the same group number (9) can be minimized, or the area and the complexity of the personalized feature pattern (4) are maximized, or the, number of the feature unit transcoding grids (11) is maximized, or the area of each feature unit transcoding grid (11) is minimized. Of course, these measures are preferably combined. The above formula gives the setting, principle and function relationship between the predetermined number n of each group and the number X of feature unit transcoding grids (11).

The personalized feature pattern (4) or the personalized feature image (20) is divided into X feature unit transcoding grids (11), wherein X≥15 or 30 or 60 or 120 or 240 or 480 or 960 or 1,500 or 3,000; and the X feature unit transcoding grids (11) are preferably arranged into a grid shape. According to the needs of typesetting and aesthetics, the X feature unit transcoding grids (11) can also be arranged into templates of various appropriate geometries (such as circle, square, diamond, pentacle and quincunx, for example, FIG. 24 is a square template in embodiments of the present invention, FIG. 25 is a hollow square template in embodiments of the present invention, FIG. 26 is a circular template in embodiments of the present invention, FIG. 27 is a hollow circular template in embodiments of the present, invention, FIG. 28 is a pentacle template in embodiments of the present invention, FIG. 29 is a hexagonal template in embodiments of the present invention, FIG. 30 is a cruciform template in embodiments of the present invention, FIG. 31 is a ring-shaped template in embodiments of the present invention, FIG. 32 is a square template with a hollow lower part in embodiments of the present invention, FIG. 33 is a square template with space left at the upper left corner in embodiments of the present, invention, and FIG. 34 is a hollow square template in embodiment 1 of the present invention), and templates of all, geometries are respectively assigned with a unique template number (23).

\textcircled{3} Each feature unit transcoding grid (11) has an area of s(mm2), wherein 0.05×0.05≤s≤2×2, or 0.05×0.05≤s≤1.5×1.5, or 0.05×0.05≤s≤1×1, or 0.05×0.05≤s≤0.5×0.5, or 0.05×0.05≤s≤0.25×0.25, or 0.05×0.05≤s≤0.1×0.1. The lower limit of 0.05×0.05 mm2 selected here is set based on the resolution (greater than 8 megapixels) of the current mainstream smart phone lens. The key point in the wide applicability of the present invention is that the current smart phone is an existing, available tool for vast consumers. Only when the lower limit of the area of the feature unit transcoding grid (11) is set to 0.05×0.05 mm2, and a set of printing and parsing technical standards is established with the resolution (greater than 8 megapixels) of the current mainstream smart phone lens as the lower limit, does the present invention have the wide applicability in which vast consumers can participate.

\textcircled{4} The group number (9) comprises the link URL of the commodity (2) information; or, the group number (9) is the two-dimensional code of an applet of WeChat.

\textcircled{5} The group number (9) and the personalized feature pattern (4) in the personalized feature area (3) on the commodity is scanned with the client (7), and the group number (9) data and the personalized feature code (5) are parsed with the client (7) from the group number (9) and the personalized feature pattern (4) according to the predetermined rule.

\textcircled{6} The diameter/width of each visible dot/line is great than or equal to 0.05 mm.

\textcircled{7} The commodity code (1) is split into a fixed code segment and a variable code segment, wherein the fixed code segment can be printed in the personalized feature area (3) on the commodity (2). and the variable code segment is not printed on the commodity (2).

\textcircled{8} The commodity code (1) is not fully printed on the commodity (2), and only the local code segment is printed on the commodity (2).

\textcircled{9} The personalized, feature pattern (4) is dried and cured to be stable and unchanged.

\textcircled{10} The X feature unit transcoding grids (10) are arranged into a grid shape.

\textcircled{11} The template number (23) of the feature unit transcoding grids (11) is printed in the personalized feature area (3) for the client (7) to invoke the feature unit transcoding grids (11) of the corresponding template during parsing, and scanning to parse the personalized feature code (5). In this way, in specific application, the feature unit transcoding grid (10) templates with different specifications can be selected according to different values of the predetermined number n and different areas of the personalized feature area (3). Preferably, the template number (23) is included in the group number (9), in other words, the template number (23) can be a code segment in the group number (9).

The personalized feature codes (5) or/and the commodity codes (1) of a plurality of commodities (2) in the same packing unit are associated; for example, the personalized feature codes (5) of a plurality of commodities (2) in the same packing box and the box code are associated and stored on the current tracing query platform.

\textcircled{12} The area of the personalized feature area (3) is preferably 8 mm×8 mm to 48 mm×48 mm. This is because the area that is too small easily causes, the uniqueness of the personalized feature pattern (4) not to be strong enough, thus causing number repetition of the personalized feature code (5), and the area that is too large easily causes much commodity (2) packages not to have enough space.

\textcircled{14} The template number (23) is the local code segment within the group number (9).

The personalized pattern-based commodity virtual code assignment system of the present invention has the following technical solution.

The present invention provides a personalized pattern-based commodity virtual code assignment system at the same time of providing the above personalized pattern-based commodity virtual code assignment method, comprising:

\textcircled{1} personalized feature pattern printing equipment, used to set a personalized feature area (3) on the commodity (2) and print naturally formed and visible random dots or/and lines or/and planes to form at least one random personalized feature pattern (4) which is unique within the predetermined number on each commodity (2):

\textcircled{2} a personalized feature information collection device, used to photograph the personalized feature pattern (4) on the commodity (2) to obtain a random personalized feature image (20) which is unique within the predetermined number;

\textcircled{3} a parsing software readable memory, used to store predetermined rule parsing software, wherein when being executed by the processor, the parsing software parses random personalized feature codes (5) of each commodity (2) which are unique within the predetermined number based on the personalized feature image (20);

\textcircled{4} a user client (7), comprising a scanning device and a parsing device, wherein the scanning device is used to scan the personalized feature pattern (4) on the commodity (2); and the parsing device is used to parse the scanned personalized feature pattern (4) to acquire a personalized feature code (5) and upload the personalized feature pattern (4) and the personalized feature code (5) to the server (6) as the personalized feature information;

\textcircled{5} a server (6), comprising a data memory, a communication module and a retrieval device, wherein the data memory is used to back up and store the personalized feature image (20) and the personalized feature code (5) parsed based on the personalized feature image (20), and associate and store at least one unique commodity code (1) of each commodity (2), the personalized feature image (20) used as personalized feature information and the parsed personalized feature code (5); the communication module is used to communicate with the client (7) so as to receive the personalized feature information uploaded from the client (7); and the retrieval device is used to retrieve the commodity code (1) in the data memory based on at least one part of the personalized feature information when the communication, module receives the personalized feature information, and to send the retrieved commodity code (1) to the client (7) through the communication module.

A personalized pattern-based commodity virtual code assignment system comprises:

\textcircled{1} personalized feature pattern printing equipment, used to set a personalized feature area (3) on the commodity (2) and print naturally formed and visible random dots or/and lines or/and planes to form at least one random personalized feature pattern (4) which is unique within the predetermined number on each commodity (2);

\textcircled{2} a personalized feature information collection device, used to photograph the personalized feature pattern (4) on the commodity (2) to obtain a random personalized feature image (20) which is unique within the predetermined number;

\textcircled{3} a parsing software readable memory, used to store predetermined rule parsing software, wherein when being executed by the processor, the parsing software parses random personalized feature codes (5) of each commodity (2) which are unique within the predetermined number based on the personalized feature image (20);

\textcircled{4} I a user client (7), comprising a scanning device and a parsing device, wherein the scanning device is used to scan the personalized feature pattern (4) on the commodity (2); and the parsing device is used to parse the scanned personalized feature pattern (4) to acquire a personalized feature code (5) and upload the personalized feature code (5) to the server (6) as the personalized feature information;

\textcircled{5} a server (6), comprising a data memory, a communication module and a retrieval device, wherein the data memory is used to back up and store the personalized feature code (5) and associate and store at least one unique commodity code (1) of each commodity (2) and the personalized feature code (5) used as the personalized feature information; the communication module is used to communicate with the client (7) so as to receive the information uploaded from the client (7) or send information to the client (7); and the retrieval device is used to retrieve the commodity code (1) in the data memory based on the personalized feature information when the communication module receives the personalized feature information, and to send the retrieved commodity code (1) to the client (7) through the communication module.

A personalized pattern-based commodity virtual code assignment system comprises:

\textcircled{1} personalized feature pattern printing equipment, used to set a personalized feature area (3) on the commodity (2) and print naturally formed and visible random dots or/and lines or/and planes to form at least one random personalized feature pattern (4) which is unique within the predetermined number on each commodity (2);

\textcircled{2} a personalized feature information collection device, used to photograph the personalized feature pattern (4) on the commodity (2) to obtain a random personalized feature image (20) which is unique within the predetermined number;

\textcircled{3} a user client (7), comprising a scanning device which is used to scan the personalized feature pattern (4) on the commodity (2) and upload the personalized feature pattern (4) to the server (6) as the personalized feature information;

\textcircled{4} a server (6), comprising a data memory, a communication module and a retrieval device, wherein the data memory is used to back up and store the personalized feature code (5) and associate and store at least one unique commodity code (1) of each commodity (2) and the personalized feature pattern (4) used as the personalized feature information; the communication module is used to communicate with the client (7) so as to receive the information, uploaded from the client (7) or send information to the client (7); and the retrieval device is used to retrieve the commodity code (1) in the data memory based on the personalized feature information when the communication module receives the personalized feature information, and to send the retrieved commodity code (1) to the client (7) through the communication module.

A personalized pattern-based commodity virtual code assignment system comprises:

\textcircled{1} personalized feature pattern printing equipment, used to set a personalized feature area (3) on the commodity (2) and print naturally formed and visible random dots or/and lines or/and planes to form at least one random personalized feature pattern (4) which is unique within the predetermined number on each commodity (2);

\textcircled{2} a personalized feature information collection device, used to photograph the personalized feature pattern (4) on the commodity (2) to obtain a random personalized feature image (20) which is unique within the predetermined number;

\textcircled{3} a parsing software readable memory, used to store predetermined rule parsing software, wherein when being executed by the processor, the parsing software parses random personalized feature codes (5) of each commodity (2) which are unique within the predetermined number based on the personalized feature image (20);

\textcircled{4} a user client (7), comprising a scanning device and a parsing device, wherein the scanning device is used to scan the, personalized feature pattern (4) on the commodity (2); and the parsing device, is used to parse the scanned personalized feature pattern (4) to acquire a personalized feature code (5) and upload the personalized feature code (5) to the server (6) as the personalized feature information;

\textcircled{5} a server (6), comprising a data memory, a communication module and a retrieval device, wherein the data memory is used to back up and store the personalized feature image (20) and associate and store at least one unique commodity code (1) of each commodity (2) and the personalized feature image (20) used as the personalized feature information; the communication module is used to communicate with the client (7) so as to receive the information, uploaded from the client (7) or send information to the client (7); and the retrieval device is used to retrieve the relevant information of commodities in the data memory based on the personalized feature information when the communication module receives the personalized feature information, and to send the retrieved relevant information of commodities to the client (7) through the communication module.

In, the technical solution further comprising a parsing device of the personalized pattern-based commodity virtual code assignment system, the parsing device is not limited to be located on the user client but also can be located on the server (6), after the personalized feature pattern (4) uploaded from the client (7) is received on the server (6), the parsing device located on the server (6) parses the personalized feature pattern (4) to obtain the personalized feature code (5), or the parsing device can be located in the relevant node, of the network, and after parsing the personalized feature pattern (4) to obtain the personalized feature code (5) in the relevant node of the network, the parsing device sends the personalized feature code (5) to the server (6). The process of parsing the scanned personalized feature pattern (4) to acquire the personalized feature code (5) comprises the situation of directly parsing the personalized feature pattern (4) according to the predetermined rule, and also comprises the situation of obtaining the personalized feature image (20) based on the personalized feature pattern (4) and parsing the personalized feature image (20) according to the predetermined rule.

The personalized pattern-based commodity virtual code assignment system further has at least one of the following features.

\textcircled{1} The personalized feature pattern printing equipment is used to print the personalized feature pattern (4) including image trans coding coordinates (10) or/and feature unit transcoding grids (11); the parsing software parses the random personalized feature code (5) of each commodity (21 which is unique within the predetermined number based on the personalized feature pattern (4) and the image transcoding coordinates or/and feature unit transcoding grids (11) on the scanned personalized feature image (20) when being executed by a processor; and the parsing device acquires the personalized feature code (5) according to the personalized feature pattern (4) or the image transcoding coordinates (10) or/and feature unit transcoding grids (11) on the scanned personalized feature image (20) when parsing the scanned personalized feature pattern (4).

\textcircled{2} The personalized feature pattern printing equipment is used to print the personalized feature pattern (4) including feature unit transcoding grids (11); the parsing software parses the random personalized feature code (5) of each commodity (2) which is unique within the predetermined number based on the feature unit transcoding grids (11) on the personalized feature image (20) when being executed by the processor, and different personalized features of feature units in the feature unit transcoding grids (11) are respectively expressed by different characters; and the parsing device acquires the personalized feature code (5) according to the feature unit transcoding grids (11) when parsing the scanned personalized feature pattern (4), and different personalized features of feature units in the feature unit transcoding grids (11) are respectively expressed, by different characters.

The personalized pattern-based commodity virtual code assignment system further can select one of the following features.

\textcircled{1} The parsing software conducts parsing for multiple times based on the personalized feature image (20) and the multiple predetermined parsing rules when being executed by a processor to obtain multiple random personalized feature codes (5) of each commodity (2) which are unique within the predetermined number; the parsing device acquires multiple personalized feature codes (5) according to the personalized feature image (20) and the multiple predetermined parsing rules when parsing the scanned personalized feature pattern (4); and the retrieval device is used to retrieve multiple commodity codes (1) in the data memory based on multiple pieces of personalized feature information when the communication module receives the multiple pieces of personalized feature information, to compare the multiple commodity codes (1) to obtain the, repeated commodity codes (1) and to send the repeated commodity codes (1) to the client (7) through the communication module.

\textcircled{2} The retrieval device is used to retrieve multiple commodity codes (1) in the data memory based on multiple pieces of personalized feature information when the communication module receives the multiple pieces of personalized feature information, to compare the multiple commodity codes (1) to obtain the repeated commodity codes (1) and to send the repeated commodity codes (1) to the client (7) through the communication module.

\textcircled{3} The parsing software assigns grid lines of different widths to the same personalized feature image (20) when being executed, by the processor, and parses multiple random personalized feature codes (5) of each commodity (2) which are unique within the predetermined number based on the personalized, feature image (20) and the grid lines of different widths; the parsing software assigns, grid lines of different widths to the same personalized feature image (20) when parsing the scanned personalized feature pattern (4), and parses multiple random personalized feature codes (5) of each commodity (2) which are unique within the predetermined number based on the personalized feature image (20) and the grid lines of different widths; and the retrieval device is used to retrieve multiple commodity codes (1) in the data memory based on multiple pieces of personalized feature information when the communication module receives the multiple pieces of personalized feature information, to compare the multiple commodity codes (1) to obtain the repeated commodity codes (1) and to send the repeated commodity codes (1) to the client (7) through the communication module.

The commodity code (1) of the present invention generally refers to the unique code owned by and only belonging to each commodity (2), i.e., commodity code (1) known as one code for one commodity. The commodity code can be Arabic numeral, letter, code formed by combining digits, letters and other characters, or natural sequence code, for example, commodity serial number, natural sequence code with random character, and link URL comprising group number (9) and serial number. The commodity code can be, classified as traceability code, logistics code, anti-counterfeiting numerical code, production date accurate to second, redeem code, point code, marketing code, Chinese drug electronic supervision code and other numerical codes by use. Refer to the book “Digital Anti-Counterfeiting Technology” (Book Number 9787506626910) published by China Standards Press in April 2002. The book introduces a coding, rule and standard for the current commonly used commodity code (1): commodity code (1) structure=industry code+area code+enterprise code+product number+product serial number+random code+area control code, wherein industry code+area, code+enterprise code+product number+area control code constitute the fixed code segment, and product serial number+random code constitute the variable code segment.

The personalized feature code (5) of the present invention is a group (or groups or strings) of codes formed by extracting and converting the main, personalized features of the random personalized feature pattern (4) according to the predetermined rule. The code may be distorted to a certain extent after being restored into an image. For example, the group number (9) and the personalized feature code (5) converted from the group number (9) and the personalized feature pattern (4) in FIG. 1 according to a certain predetermined rule are codes: 20108/101000/1100110/00100101/1010/0100100/1000101. The code may be distorted to a certain extent after being restored into an image (as shown in FIG. 7), but the restored image (as shown in FIG. 7) is more similar to the current two-dimensional code.

In other words, the personalized feature code (5) of the present invention is equivalent to compressing the random personalized feature image (20) according to the predetermined rule, and the personalized feature code (5) is the compressed data. The larger the compression ratio is, the shorter the personalized feature code (5) is, and the larger the compression distortion is. In specific implementation, any compression ratio that can ensure the uniqueness of the personalized feature code (5) in the same group (i.e., predetermined number n) can be used.

As is well-known, the current two-dimensional code pattern is a personalized feature pattern, but it is formed by arranging regular black/white color blocks with fixed geometry on a plane (in the two-dimensional direction) according to the predetermined rule, wherein the black/white color blocks are not randomly arranged dots/lines/planes. The random personalized feature pattern (4) of the present invention is formed by visible random dots or/and lines or/and planes distributed randomly—naturally formed.

The “fiber (13)” of the present invention generally refers to various tiny and short objects that have a certain contrast with the background color, for example, hair, chemical fiber, glitter, chip, particle and flock powder. The best is chemical fiber with, the length of 0.3 to 2.8 mm and the width of 0.02 to 0.2 mm.

The predetermined rule of the present invention generally refers to the image code conversion technical standard in the image recognition technology, also known as image code conversion technical protocol or image code conversion technical regulation, which can extract and (forward) convert the main personalized feature information from, the personalized feature image (20) to the corresponding personalized feature code (5) The conversion can be similar to lossy image compression, is difficult to (reversely) restore, and can adopt modes of statistical pattern recognition, structural pattern recognition and fuzzy pattern recognition, and image segmentation can be performed with various methods such as threshold segmentation method, edge detection method and area extraction method. The personalized feature code (5) parsed (i.e., converted) according to the predetermined rule is convenient for data storage and retrieval. With a vivid metaphor, the predetermined rule is a password book, the personalized feature pattern (4) is a treasure map, the two have a corresponding relation, the hidden password can be found by comparing the password book with the treasure map, and the commodity code (1) can be found according to the password.

The words “natural” and “naturally formed” in the present invention generally refer to various random formation methods not controlled by human will, including purely natural random formation methods and random formation methods such as printing/coating/spraying processes. For example, distribution feature of randomly sprayed ink droplets, distribution feature of randomly scattered glitter, distribution feature of randomly coated fibers, distribution, feature of sawteeth randomly diffused after printing, distribution feature of cracks randomly splitting after printing, and distribution feature of bubbles randomly foaming after printing. The formation of these random distribution features is not controlled by human will. and these random distribution features are all naturally formed and equivalent to naturally growing features. Therefore, the word “natural” is used in the present invention, but the meaning is not limited to purely natural. In view of this, the meaning of “personalized feature pattern” in the description of the present invention includes naturally growing personalized feature pattern (4) (such as purely natural patterns such as wood grain/marbling,) as well as texture inherent in texture paper and personalized feature pattern (4) randomly formed after printing (such as sawteeth formed by random diffusion of ink/randomly scattered glitter/'ink, spots). As is well-known, 7.4 billion people in the world each have a unique fingerprint, and no two people have exactly the same, fingerprints. As with fingerprints of people, these naturally formed personalized feature patterns (4) have uniqueness, and within the predetermined number n, no two identical personalized feature patterns (4) will appear.

The personalized feature patterns (4) of the present invention comprise naturally formed random parts (variable features), and also comprise the, printed group number (9), template number (23), image transcoding coordinates (10), feature unit, transcoding grids (11). position detection patterns (19) and other fixed parts (fixed features). In terms of formation methods of the personalized feature patterns (4), artificially printed personalized feature patterns (4) are included, for example, the current two-dimensional code pattern formed by arranging black and white color blocks according to the QR coding, rule is a personalized feature pattern (4) artificially designed and printed with a digital printer; and naturally formed personalized feature patterns (4) are also included, for example, crack patterns in FIG. 11 and FIG. 17 are naturally formed personalized feature patterns (4). The beneficial technical effects of the present invention are derived from using naturally formed technical means to form a personalized feature pattern (4) and conducting virtual code assignment on commodities based on the personalized feature pattern (4). Compared with printing the current QR, two-dimensional code patterns, printing naturally formed personalized feature patterns (4) required by the present invention is much easier and cheaper and requires less equipment investment. Because of this advantage, the present invention has broad application prospects.

The commodity code (1) of the present invention is composed of multiple segments of serial numbers of the fixed code segment and the variable code segment. The fixed code segment can be printed with a traditional forme-based printing machine as the group number (9), and the serial number of the variable code segment is now printed with a digital printer in most printing plants. The change of the group number (9) needs to be realized by forme replacement. The forme of a folio offset printing press can typeset 10 to 18 product packages on average. For example, if the predetermined number n within, the same group number (9) is 100,000, the group number (9) forme needs replacing every time 1,000,000 to 1,800,000 packages (requiring 1 to 2 shifts) are printed. The forme replacement frequency does not affect, normal printing production and thus is acceptable for vast printing plants.

The group number (9) of the present invention generally refers to a symbol such as any code that can indicate uniqueness, for example, a code compiled by letter, number. text, customized color block, customized dot and line, and other elements.

The positioning patterns or/and position detection patterns (19) of the present invention generally refer to various appropriate patterns or line segments, not limited to the patterns and line segments that have been drawn in the drawings of the description.

The client (7) of the present invention is a current smart phone, and a cellphone or other terminal equipment installed with predetermined rule parsing software.

The commodity code (1), the personalized feature code (5) and other information can be parsed by using the client (7) to scan a pattern composed of a personalized feature pattern (4), a group number (9), a graduated scale (22), a template number (23), positioning patterns, position detection patterns (19) and other elements in the personalized feature area (3) of the present invention, and the function, is the same as scanning the current QR two-dimensional code to parse the relevant information. Therefore, in the present invention, the patterns in the personalized feature, area (3) are collectively called natural two-dimensional codes, known as natural codes for short.

The personalized features of the feature units of the present invention refer to various visible features (to the naked eyes) in the feature unit transcoding grids (11), for example, color of ink, shape of line, length of line, direction or curvature or number of lines, and number or size or color of dots. The visible features (to the naked eyes) are respectively expressed by different characters, and arranged according to the predetermined arrangement sequence of the feature unit transcoding grids (11) so that the physical features of the personalized feature pattern (4) are converted to the personalized feature code (5) and other digital features. Refer to the following contrast examples of personalized features of feature units and characters: white=0, black=1, red=2, green=3, blue=4, dot=5, line=6, curve32 7, sawtooth=8, etc.

Reference signs such as (1), (2), (3), (4) and (5) are used, in the description and claims of the present invention, and these reference signs are only convenient for readers to intuitively understand the present invention and do not constitute a limitation to the present invention.

Compared with the prior art, the present invention can yield the following beneficial technical effects:

The personalized pattern-based commodity virtual code assignment method and system of the present invention can print commodity codes (1) and other variable codes on commodities (2) without a digital printer, which not only can save the investment in code assignment equipment, but also can increase code assignment speed, reduce code assignment cost and ensure code assignment quality. The survey shows that the global sales volume of digital printers is 120.9 billion dollars in 2013. The sales volume is expected to reach 272 billion dollars by 2024. These digital printers are mainly used for assigning codes to commodities. It can be seen that the promotion and application of the present invention can save hundreds of billions of dollars of equipment investment and code assignment cost for the whole society each year. Commodity production enterprises in China pay at least 60 billion yuan as the code assignment cost each year.

The scanned commodity code (1) conforms to the current coding structure and standard, and can be used as the commodity (2) ID number which is one for one commodity. Various current computer application systems can use the commodity code (1) without update or modification.

With the rapid development of cloud computing technology, 5G communication network (24) technology, artificial intelligence technology and image recognition technology, the present invention will be more and more widely used.

With the method of printing personalized patterns and associating commodity codes, the present invention opens up another way to complete the commodity code assignment task and creates the code assignment of non-digital printers.

### BRIEF DESCRIPTION OF THE DRAWINGS

FIG. 1 is a schematic diagram of a code assigned commodity (with glitter random distribution pattern) in embodiment 1 of the present invention.

FIG. 2 is a schematic diagram of a code assigned commodity (with random wrinkle pattern) in embodiment 2 of the present invention.

FIG. 3 is a schematic diagram of a code assigned commodity (with random foaming pattern) in embodiment 3 of the present invention.

FIG. 4 is a schematic diagram of a code assigned commodity (with random sawtooth pattern) in embodiment 4 of the present invention.

FIG. 5 is another schematic diagram of a code assigned commodity (with fiber random distribution pattern) in embodiment 1 of the present invention.

FIG. 6 is a schematic diagram showing a principle of parsing a commodity code by a cellphone client in embodiments of the present invention.

FIG. 7 is a schematic diagram of personalized feature code restoration in embodiment 1 of the present invention.

FIG. 8 is a schematic diagram of a code assigned commodity (with random snow/ice flower pattern) in embodiment 5 of the present invention.

FIG. 9 is a schematic diagram of a code assigned commodity (with random texture pattern) in embodiment 6 of the present invention.

FIG. 10 is a schematic diagram of a code assigned commodity with another feature unit transcoding grid (160 grids) in embodiment 1 of the present invention.

FIG. 11 is another schematic diagram of a code assigned commodity (with random ink crack pattern) in embodiment 2 of the present invention.

FIG. 12 is a schematic diagram of a code assigned commodity (with sprayed ink random distribution pattern) in embodiment 7 of the present invention.

FIG. 13 is another schematic diagram of personalized feature code restoration, in embodiment 1 of the present invention.

FIG. 14 is a commodity diagram of dividing the code assigned commodity shown in FIG. 5 into multiple cells for code assignment.

FIG. 15 is a schematic diagram of two critical images in embodiment 8 of the present invention.

FIG. 16 is a schematic diagram of a code assigned commodity (combining randomly distributed glitter and commodity bar code) in embodiment 10 of the present invention.

FIG. 17 is another schematic diagram of a code assigned commodity (combining random ink crack and commodity bar code) in embodiment 10 of the present invention.

FIG. 18 is another schematic diagram of a code assigned commodity (combining random sawtooth and commodity bar code) in embodiment 10 of the present invention.

FIG. 19 is a schematic diagram of photo parsing of the commodity bar code in FIG. 16.

FIG. 20 is a schematic diagram of a personalized feature pattern and the personalized feature image thereof in embodiment 11 of the present invention.

FIG. 21 is a schematic diagram of a personalized feature pattern formed by a kind of thermochromic spots in embodiment 12 of the present invention.

FIG. 22 is a (local) schematic diagram of a medicine box printed with the current Chinese drug electronic supervision code.

FIG. 23 is a schematic diagram of a code assigned commodity (with thermochromic spots/glitter) in embodiment 5 of the present invention.

FIG. 24 is a (X=20×18) square template in embodiments of the present invention.

FIG. 25 is a (X=20×18−14×12) hollow (placeholder for group number) square template in embodiments of the present invention.

FIG. 26 is a circular template in embodiments of the present invention.

FIG. 27 is a hollow (placeholder for group number) circular template in embodiments of the present invention.

FIG. 28 is a pentacle template in embodiments of the present invention.

FIG. 29 is a hexagonal template in embodiments of the present invention.

FIG. 30 is a cruciform template in embodiments of the present invention.

FIG. 31 is a ring-shaped template in embodiments of the present invention.

FIG. 32 is a square template with a hollow lower part (placeholder for group number) in embodiments of the present invention.

FIG. 33 is a square template with space left at the upper left corner (placeholder for group number) in embodiments of the present invention

FIG. 34 is a hollow square template used in embodiment 1 (FIG. 1) of the present invention.

Reference signs: 1—commodity code, 2—commodity, 3—personalized feature area, 4—personalized feature pattern, 5—personalized feature code, 6—server, 7—client, 8—ink, 9—group number, 10—image transcoding coordinate, 11—feature unit transcoding grid, 12—glitter, 13—fiber, 14—sawtooth, 15—random texture, 16—database, 17—coarse grid line, 18—commodity bar code, 19—positioning pattern or/and position detection pattern, 20—personalized feature image, 21—thermochromic spot, 22—graduated scale, 23—template number, 24—communication network.

### DETAILED DESCRIPTION

To make the above-mentioned purpose, features and advantages of the present invention, more clear and understandable, comprehensive preferred embodiments will be described below in detail in combination with the drawings.

### Embodiment 1

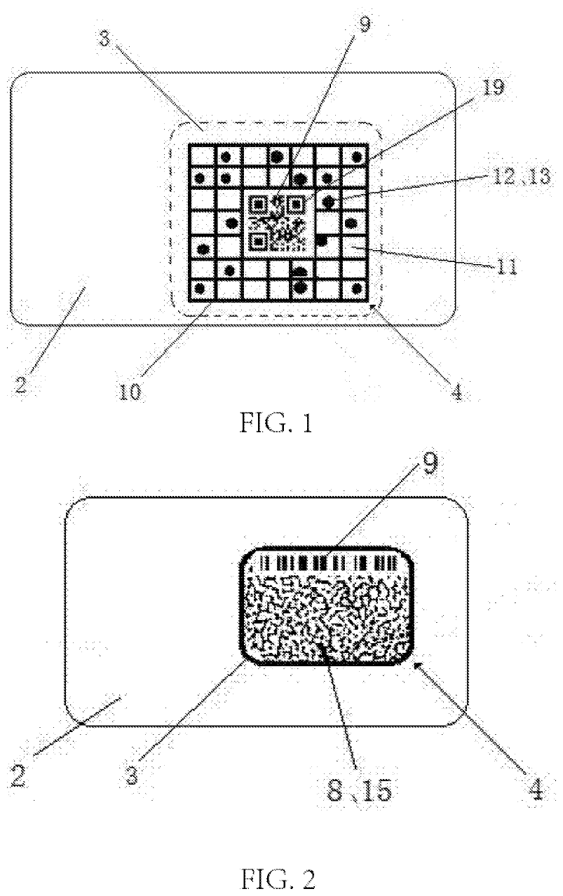

As shown in FIG. 1, a pet film with the thickness of 35 μm is selected to print salt commodity (2) bags of 500g. If there is a need to trace source codes for 5 billion, bags of salt commodities (2) in total, each bag of salt commodity (2) is assigned with a unique commodity code (1), for example, 20108000001, 20108000002, 20108000003, 20108000004 . . . n and other natural sequence codes. The commodity code (1) is used as a trace code. There is no need to print the commodity code (1) on the bag of the salt commodity (2). Every 100,000 (that is, n=100,000) bags are divided into one group, and each group is assigned with a unique group number (9). The group number (9) is printed on the salt commodity (2) bags in the form of a fixed two-dimensional code (that is, a fixed code segment). In this way, 5 billion bags of salt commodities (2) can be assigned with 50,000 different group numbers (9) in total. For example, natural sequence codes, such as 00001, 0002, 0003, 00004, 0005, 20108 . . . are used as group, numbers (9), that is, used as fixed code segments of the commodity codes (1).

Printing personalized feature patterns: circling a 21 mm×21 mm area on the pet film as a personalized feature area (3), printing a two-dimensional code representing the group number (9) in the middle position of the area, and printing 40 feature unit transcoding grids (11) with the template number (23) of 001 around the two-dimensional code. The feature unit transcoding grids (11) may be printed as red lines, and the size of each feature unit transcoding grid may be set to 3 min×3 mm.

In order to make the parsed personalized feature codes (5) more personalized, the feature unit transcoding grids (11) may be set smaller and the number X may be set more. In the embodiment shown in FIG. 10, the size of the feature unit transcoding grid with the template number (23) of 002 may be set to 1.5 mm×1.5 mm. In this way, the number X of the feature unit transcoding grids (11) in the original 21 mm×21 mm personalized feature area (3) may be increased from 40 to 160.

By means of the patent technology “local large-size fiber letterpress printing system and printed matter thereof (authorized announcement No.: CN103042814B)”, feature unit transcoding grids (11), a two-dimensional code representing the group numbers (9) and ink (8) containing glitter (12) are printed on the pet film, and thus numerous glitter (12) black dots are randomly distributed in the ink (8) in the personalized feature area (3), to form the personalized feature pattern (4) of the present invention.

Collecting personalized feature information: photographing the two-dimensional code representing the group number (9) and the personalized feature pattern (4) formed by the feature unit transcoding grids (11) and the numerous glitter (12) black dots on each salt commodity (2) packing bag by a digital camera (for example, an industrial digital camera), and storing all 5 billion digital photos (i.e. images) into the preset database (16) of the server (6) on the communication network (24) in combination with the group numbers (9) thereof, that is, storing in the database (16) of the server (6) according to the group numbers (9).

In, order to save data storage space, as well as to increase the retrieval speed and improve the user experience, all archive photos (i.e. images) can be parsed into personalized, feature codes (5) respectively according to predetermined rules. As shown in FIGS. 1 and 34, a predetermined rule is formulated: by using 40 red feature unit transcoding grids with a template number (23) of 001, setting that 1 represents that there are black glitter (12) in the feature unit transcoding grids (no matter how many/half included); setting that 0 represents that there is no glitter (12) in the feature unit transcoding grids (11); printing the group number (9) with a QR two-dimensional code; and encoding, and parsing according to the arrangement sequence of the feature unit transcoding grids (11) from left to right and from top to bottom. According to this predetermined rule, the group number (9) and the personalized feature pattern (4) in FIG. 1 may be parsed into a group number (9) and a personalized feature code (5):

20108/101000110011000100101101001001001000101 (if changed to decimal format, it can be expressed as Arabic numeral 20108/350452355653), where 20108 is a group of digits scanned based on the two-dimensional code representing the group number (9), that is, a fixed code segment of the commodity code (1); and 350452355653 is a group of digits parsed from the personalized feature pattern (4), that is, a variable code segment of the commodity code (1).

Of course, in order to enhance the uniqueness, and complexity of the personalized feature code (5), other predetermined rules can also be set, for example, by using 40 red feature unit transcoding grids (11), set that 1 represents that there is one black glitter (12) in, the feature unit transcoding grid (11), 2 represents that there are two black glitter (12) in the feature unit transcoding grid, 2 represents that there are three black glitter (12) in the feature unit transcoding grid, 4 represents that there are four black glitter (12) in the feature unit transcoding grid, 5 represents that there are five or more black glitter (12) in the feature unit transcoding grid, and 0 represents that there is no black glitter (12) in the feature unit transcoding grid, to parse personalized feature codes (5) based on the feature unit transcoding grids (11) on the personalized feature pattern (4).

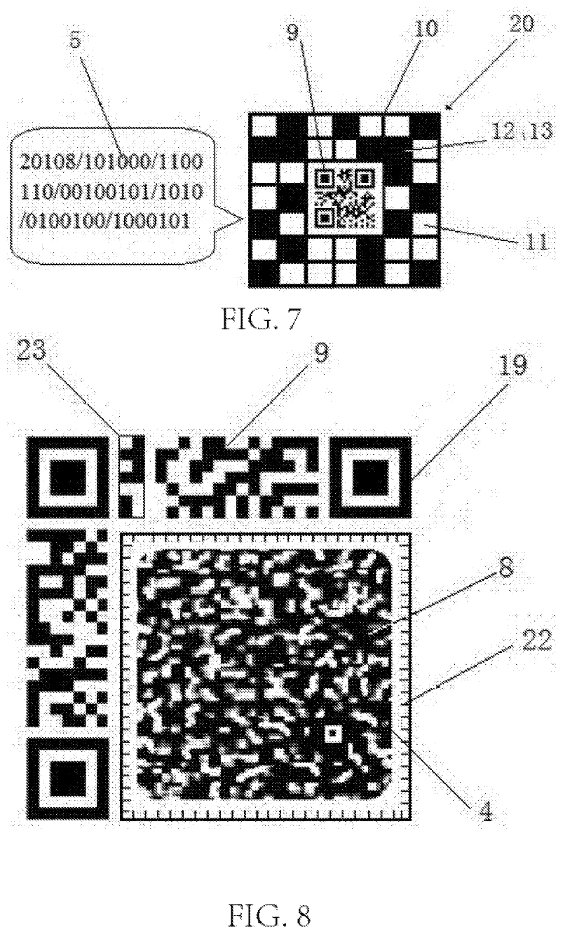

The personalized feature code (5) of the present invention is a unique character string obtained by extracting and converting the main personalized features of the personalized feature pattern (4) according to the predetermined rule. The character string may be distorted to a certain extent after being restored into an image. For example, the group number (9) and the personalized feature code (5) converted from the two-dimensional code representing the group number (9) and the personalized feature pattern (4) according to a certain predetermined rule are 20108/101000/1100110/00100101/1010/0100100/1000101. The character string may be distorted to a certain extent after being restored into an image (as shown in FIG. 7), but the restored image (as shown in FIG. 7) is more similar to the current two-dimensional code pattern.

In order to reduce the scan code misreading rate, the same personalized feature image (20) can be parsed into multiple personalized feature codes (5) respectively according to a variety of different predetermined rules; the multiple personalized feature codes (5) are assigned with the same commodity code (1); in the process of backing up the personalized feature information, the multiple personalized feature codes (5) and respective commodity code (1) are stored into the preset database (10 in a one-to-one correspondence mode; the respective commodity codes (1) can be retrieved from the preset database (16) by the server (6) according to the multiple personalized feature codes (5); and among the retrieved multiple pieces of information including the commodity codes (1), if most of the information includes the same commodity code (1), it is determined that the retrieval result is correct, and the commodity code is fed back to the smart phone or the corresponding client (7). In this way, the scan code misreading rate can be reduced, and the fault tolerance rate can be increased.

In this embodiment, the personalized feature pattern is divided into 40 large feature unit transcoding grids (11) with wide red line, and each large feature unit transcoding grid (11) is divided into 4 small feature unit transcoding grids with fine red line, thus obtaining 160 small feature unit transcoding grids (11). As shown in FIG. 10, after parsing based on the 40 large feature unit transcoding grids (11) and then parsing based on the small feature unit transcoding grids (11), that is, re-parsing the group number (9) and personalized feature pattern (4) in FIG. 1 according to the predetermined rule (from left to right and from top to bottom) of the 160 feature unit transcoding grids (11), the group number (9) and another personalized feature code (5) can be obtained:

20108/00100010000001/00100010000001/10100000111100/10100000111100/00001100/00001100/00110011/00110011/11001000/11000000/00110000100000/00110000100000/10000000110001/10000000110001. The personalized feature code (5) has a binary data digit up to 160. Therefore, after the number X of the feature unit transcoding grids (11) is increased, the uniqueness within a predetermined number n can be more guaranteed. The personalized feature code (5) is less distorted after being restored into an image (as shown in FIG. 13), and the restored image (as shown in FIG. 13) is more similar to the current two-dimensional code.

The preset database (16) is networked with the server (6) by the communication network (24). Virtually assigning codes>to commodities (i.e. assigning codes to personalized feature information): assigning all the 100,000 digital photos (i.e. images) photographed with commodity codes (1) containing group numbers (9). Preferably, all the 100,000 digital photos photographed are parsed into personalized feature codes (5) according to the predetermined rules, and are assigned with commodity codes (1) containing group numbers (9) according to the real production sequence of commodities (2) on the assembly line. Assuming that FIG. 1 shows No. 000008 commodity (2), the personalized, feature code (5) thereof is correspondingly stored as 20108/00100010000001 . . . /000008after being assigned with a commodity code (1) containing a group number (9).

Parsing and accessing the commodity code (1): if a consumer needs to trace information such as the source of salt, taking a photo (including video) for the group number (9) and personalized feature pattern (4) on the salt commodity (2) packing bag with a smart phone, and uploading same to the server (6), and parsing corresponding group number (9) data and personalized feature code (5) from the uploaded photo by the server (6); or, scanning the group number (9) and personalized feature pattern (4) on the salt commodity (2) packing bag with the client (7), parsing the photographed photo, after the photo is calibrated, cut and binarized, invoking the transcoding template, after the photo is converted into a personalized feature code (5) and group number (9) by the transcoding template, uploading the parsed personalized feature code (5) and group number (9) (for example, 20108/00100010000001 . . . ) into the preset database (16); and retrieving a respective commodity code (1) (for example 000008) by the server (6) based on the personalized feature code (5) and group number (9) (for example, 20108/00100010000001 on the salt bag shown in FIG. 1) uploaded by the user, the personalized feature pattern (4) or other personalized feature information, and feeding back the retrieved commodity code (1) to the (user) client (7) or smart phone. FIG. 6 is a schematic diagram showing a principle of scanning and parsing a commodity code (1) by a client (7) in a smart phone.

As mentioned above, 5 billion bags of salt commodities (2) can be respectively assigned with a commodity code (1) that has uniqueness and sequential and complies with the current encoding rule and standard by printing the personalized feature pattern (4) using a traditional forme-based printing machine, so that product tracing, logistics management, product chain management, marketing management, point rewards, and other applications can be conducted by means of the commodity codes (1).

As mentioned above, the personalized feature pattern (4) shown in FIG. 5 and composed of a plurality of colored fibers (13) randomly distributed can be printed, according to the same process steps and methods, and each package can be assigned with a commodity code (1) having uniqueness and sequential.

### Embodiment 2

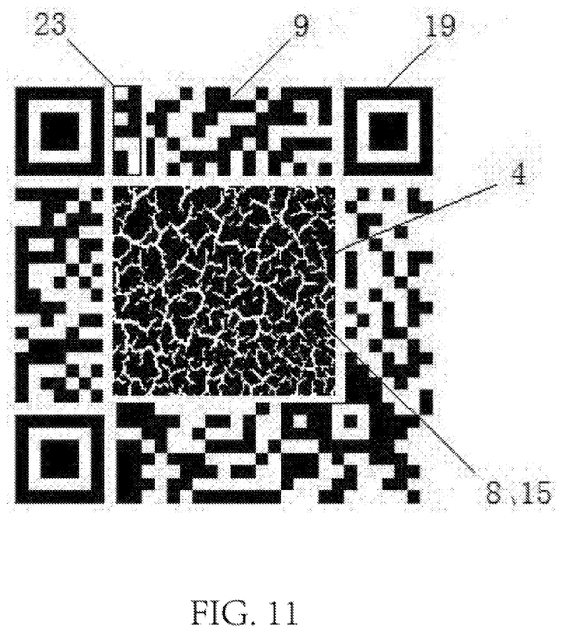

As shown in FIG. 2 and FIG. 11, a pet film with the thickness of 35 μm is selected to print bags of salt commodities (2) of 500 g. If there is a need to trace source codes for 5 billion bags of salt commodities (2), each bag of salt commodity (2) is assigned with a unique commodity code (1). There is no need to print the commodity code (1) on the bags of salt commodities (2). Every 100,000 bags are divided into one group, and each group is assigned with a unique group number (9). The group number (9) (1) is printed on the bags of salt commodities (2). In this way, 5 billion bags of salt commodities (2) can be assigned with 50,000 different group numbers (9) in total.

Printing personalized feature patterns: circling a 16 mm 26 mm area on the pet film as a personalized feature area (3), for each group of salt commodity (2) bags, printing a fixed bar code-form group number (9) in the area thereof;

printing a layer of wrinkle or crack ink (8) on the pet film using the existing gravure printing or screen, printing technology, so that the wrinkle or crack ink (8) in the personalized feature area (3) naturally forms random wrinkle or crack-random texture (15) in the drying process, thereby forming a personalized feature pattern (4). See the Chinese invention patent “UV solidified wrinkle ink (CN1727417A)” for the wrinkle printing technology. Since the wrinkle printing technology is a frequently-used mature printing technology at present, it will not be repeated, here in details.

Photographing personalized feature information and backing up the personalized feature information: photographing the group number (9) and the personalized feature pattern (4) composed of multiple wrinkles on the packing each salt commodity (2) packing bag by an industrial digital camera. and storing all 100,000 digital photos (i.e. images) into the preset database (16) in combination with the group numbers (9) thereof.

In order to save data storage space, as well as to conduct quick retrieval, all 5 billion archive photos can be parsed into personalized feature codes (5) respectively according to predetermined rules. For example, for 100 feature unit transcoding grids (11) with the template number (23) of 003, setting that I represents cracks in the horizontal direction in the feature unit transcoding grids (11), 2 represents the cracks in longitudinal direction, 3 represents crack in the direction similar to one stroke to the left, 4 represents cracks, in the direction similar to one stroke to the right, and 0 represents no crack.

All the 5 billion digital photos photographed are assigned with commodity codes (1) containing group numbers (9). Preferably, all the 5 billion digital photos (i.e. images) photographed are parsed into personalized feature codes (5) according to predetermined rules, are assigned with commodity codes (1) containing group numbers (9) according to the real production sequence of commodities (2) on the assembly line, and are stored into the preset database (16).

The preset database (16) is networked with the server (6) by the communication network (24). Parsing and accessing the commodity code (1): if a merchant or business management staff needs to trace information such as the source of salt, scanning the group number (9), template number (23) and personalized feature pattern (4) on the salt commodity packing bag with a client (7) downloaded and installed in the cellphone, parsing the photographed photo, calibrating, cutting and binarizing the photo, invoking the No. 003 template, converting the photo into a personalized feature code (5) and group numbers (9) by the transcoding template, and uploading the parsed personalized feature code (5) and group number (9) into the preset database (16); and

retrieving a respective commodity code (1) by the server (6) based o the personalized feature code (5) and group number (9) uploaded by the user, and feeding back the retrieved commodity code (1) to the (user) client (7) or smart phone. FIG. 6 is a schematic diagram showing a principle of scanning and parsing a commodity code (1) by a client (7) in a smart phone.

As mentioned above, 5 billion bags of salt commodities (2) are respectively assigned with a commodity code (1) that has uniqueness and sequential by printing the personalized feature pattern (4) such as ink crack and the like using a traditional forme-based printing machine, so that product tracing, logistics management, product chain management, marketing management, point rewards, and other applications can be conducted by means of the commodity code (1).

### Embodiment 3

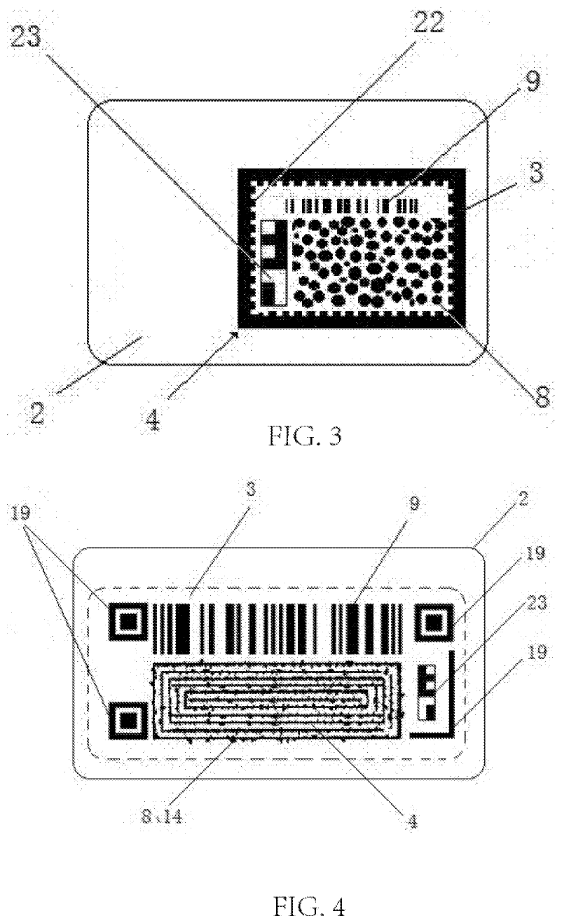

As shown in FIG. 3, the personalized feature pattern (4) is formed after foaming of foaming ink (8).

An ivory boards is selected to manufacture medicine boxes. Some milk-white UV foaming ink are prepared.

Printing personalized feature pattern comprises: printing 26 mm×16 mm foaming ink (8) on the ivory board using a screen printing machine, and illuminating using an UV solidification lamp, to make same solidified and foamed.

Printing personalized feature pattern further comprises: manufacturing a 24 mm×14 mm flexo printing board, printing on a foaming ink (8) layer with red flexo printing ink, to print and dye the crest of a bubble into red, that is, print a colored ink layer with a color different from that of the foaming ink (8) on the crest of the bubble and dry same. For the short crest, since the printing forme cannot reach it due to shortness, so it cannot be colored and dyed red.

Because each bubble is formed by random foaming, human beings cannot control the shape, size and height thereof Since their crest coloring pattern features are affected by many random factors such as crest height. foaming elasticity, foaming slope, crest area, printing forme pressure, forme hardness, worker feel, printing layer wettability, and ink permeability, the naturally formed personalized feature pattern (4) has uniqueness.

In order to facilitate the parsing software to find and determine the precise position of the image transcoding coordinate (10) line and the feature unit transcoding grid (11) according to the predetermined rule, a graduated scale (22) is printed at the edge of the personalized feature area (3) in FIG. 3, so that the parsing software generates virtual grid lines and feature unit transcoding grids (11) on the personalized feature image (20) according to the graduated scale (22) to parse personalized feature codes (5).

Photographing personalized feature information and backing up the personalized feature information: photographing the group number (9) and the personalized feature pattern (4) composed of multiple ink bubbles on each box of medicine (commodity (2)) by an industrial grade camera, and storing all (for example, 100,000) digital photos into the preset database (16) in combination with the group numbers (9).

In order to save data storage space, as well as to conduct quick retrieval, all archive photos, for examples, personalized feature patterns (4) on the digital photos are generated into 30×20 (i.e. 600) feature unit transcoding grids (11) based on the graduated scale (22) according to predetermined rules: setting that the template number (23) of the feature unit transcoding grids (11) is 004, setting that 1 represents red (including partially red) in a single virtual feature unit transcoding grid (11) and 0 represents all white in it, and binary encoding is conducted according to the sequence from left to right and from top to bottom, so that a 600-digit binary personalized feature code (5) is parsed. Of course, if the server (6) is powerful and all digital photos are stored into the database (16) of the server (6) in combination with the assigned commodity codes (1) containing group numbers (1), in the process of accessing the commodity code for subsequent parsing, the personalized feature pattern (4) on the commodity (2) is scanned with the client (7) and is uploaded to the server (6), and a respective commodity code (1) is directly retrieved by the server (6) according to the uploaded personalized feature image (20) using the artificial intelligence technology.

All the 100,000 digital photos photographed are assigned with respective 20-digit Chinese drug electronic supervision codes; and preferably, parsed into personalized feature codes (5) and group numbers (9) according to predetermined rules, and each personalized feature code (5) is assigned with a 20-digit Chinese drug electronic supervision code according to the real drug production sequence on the drug package assembly line. If the personalized feature code (5) parsed from the personalized feature pattern (4) composed of ink bubbles shown in FIG. 3 according to the predetermined rule by invoking the No. 004 template is 101000110011000100101101001001001000101,and if the Chinese drug electronic supervision code required to be assigned to the box of medicine shown in FIG. 3 is 61234567123456789012, the two can be associated together and written as 61234567123456789012/101000110011000100101101001001001000101, and converted into binary data 61234567123456789012/350452355653. Then, they are stored into the preset database (16) in a one-to-one correspondence mode.

The preset database (16) is networked with the server (6) by the communication network (24). Parsing and accessing the commodity code (1): if a merchant or business management staff needs to trace information such as the source of medicine, scanning the group number (9) and personalized feature pattern (4) on the medicine packing box with the client (7) downloaded and installed in the smart phone, parsing corresponding group number (9) data and personalized feature codes (5), and uploading the parsed group number data and personalized feature codes into the present database (16);

retrieving the respective Chinese drug electronic supervision code-commodity code (1) by the server (6) according to the personalized feature codes (5) uploaded by the user, and feeding back the retrieved Chinese drug electronic supervision code to the (user) client (7) or smart phone, so as to acquire medicine information such as the name, dosage form, specification, manufacturer, date of manufacture, batch number, and expiration date of the medicine.

See “foam ink printing handicraft and manufacturing method therefor (CN1958308A)” and “texture anti-fake marker highlighting ink foaming feature or ink wrinkle feature (CN104372715A)” for the foam printing technology. Since the foam printing technology is a frequently-used traditional printing technology at present, it, will not be repeated here in details. The remaining steps are the same as those in the above two embodiments.

### Embodiment 4

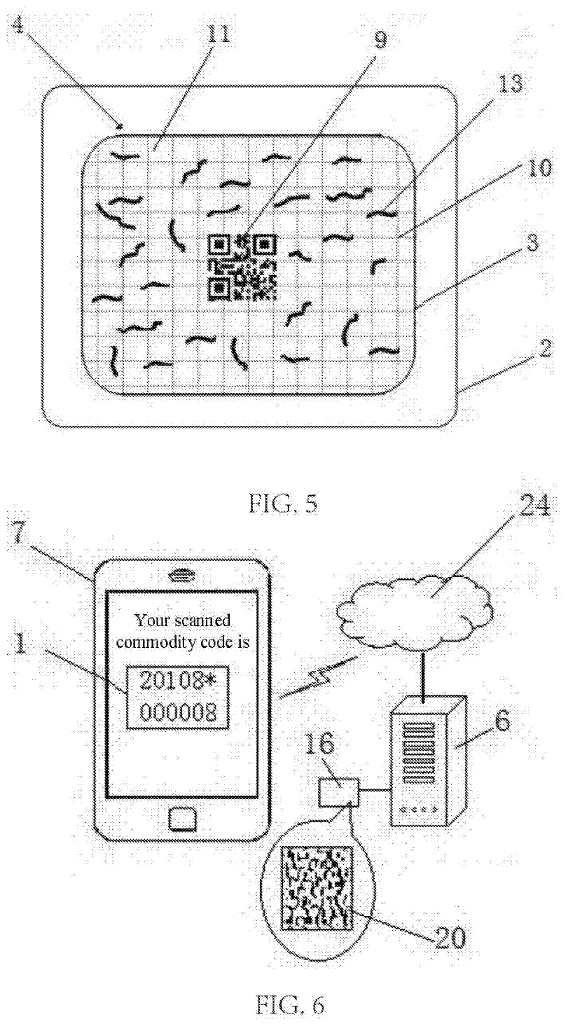

As shown in FIG. 4, the personalized feature pattern (4) can be formed using the sawtooth printing technology.

If there is a need to trace source codes for 100 million boxes of Tetra Pak milk commodities (2), each box of salt commodity (2) is assigned with a unique commodity code (1). There is no need to directly print the commodity code (1) on the commodity (2) package such as milk box, etc. Every 50,000 boxes are divided into one group, and each group is assigned with a unique group number (9). The group number (9) is printed on the 50,000 boxes of milk commodities (2) of the same group in a bar code form. In this way, the 100 million boxes can be assigned with 2000 different group numbers in total.

Printing personalized feature patterns: circling a 20 mm×30 mm area on each milk box as a personalized feature area (3), for the Tetra Pak milk commodities (2) of the same group, printing a fixed bar code-form group number (9) in the area thereof, for example, 69012341 represented by a one-dimensional bar code shown in FIG. 4;

printing a transparent diffusing agent undercoat on the personalized feature area (3) of the milk box first using the current gravure printing technology, and then printing five black rectangular, line frames with the line width of 0.1 mm on the dried diffusing agent undercoat,

wherein the printed black ink (8) line with the width of 0.1 mm may be rapidly diffused at random under the action of the surface tension of the diffusing agent undercoat, thus some random sawteeth (commonly called burr) are naturally formed at the edge of the ink (8) line, thereby forming a personalized feature pattern (4). See the Chinese utility model patent “sawtooth-code anti-fake printed matter (authorized announcement No.: CN204833342U)” and the Chinese invention patent “sawtooth anti-fake method for mobile phone identification codes (authorized announcement No.: CN104794629B)” for the sawtooth printing technology. Since the sawtooth printing technology is a mature printing technology at present, it will not be repeated here.

Collecting personalized feature information: photographing the group number (9) and the personalized feature pattern (4) composed of multiple sawteeth on the package of each box of milk commodity (2) by an industrial camera, and storing all 100,000 digital photos into the preset database (16) by taking the group number (9) thereof as the folder name.

In order to save data storage space, as well as to conduct quick retrieval, all 100 million archive photos are parsed into personalized feature codes (5) respectively according to predetermined rules, for example: 5 rectangular line frames with a total length of 300 mm are divided into 100 line segments each having a length of 3 mm, the line segments are respectively placed into 100 virtual feature unit transcoding grids (11): setting that 1 represents one sawtooth (neglecting height less than 0.05 mm) on the line segment in the feature unit transcoding grid (11), 2 represents two sawteeth, 3 represents three sawteeth, 4 represents four sawteeth, S represents five sawteeth and more, and 0 represents no sawtooth.

All the 100 million digital photos photographed are assigned with commodity codes (1) containing group numbers (9). Preferably, all the 50,000 digital photos photographed are parsed into personalized feature codes (5) according to predetermined rules, and are assigned with commodity codes (1) containing group numbers (9) according to the real production sequence of the milk commodities (2) on the assembly line. All the personalized feature codes (5) are associated with the commodity codes (1) containing group numbers (9) and stored into the preset database (16) in a one-to-one correspondence mode.

Parsing and accessing the commodity code (1): if a consumer, merchant, or business management staff needs to trace information such as the source of milk commodities (2), scanning the group number (9) and personalized feature pattern (4) on the packing box of a milk commodity (2) with the client (7) downloaded and installed in the smart phone, parsing corresponding personalized feature codes (5) and group number (9) data, and uploading the parsed personalized feature codes (5) and group numbers (9) data into the present database (16) of the server (6) connected to the communication network (24); and retrieving a respective commodity code (1) by the server (6) based on the personalized feature codes (5) and group number (9) data uploaded by the user, and feeding back the retrieved commodity code (1) to the client (7) or smart phone.

As mentioned above, 100 million boxes of milk commodities (2) are respectively assigned with a commodity, code (1) that has uniqueness and sequential by forming personalized feature patterns (4) such, as sawteeth, etc. by diffusing the ink (8) line using the traditional forme-based printing machine, so that product tracing, logistics management, product chain management, marketing management, point rewards, and other applications can be conducted by, means of the commodity code (1).

### Embodiment 5

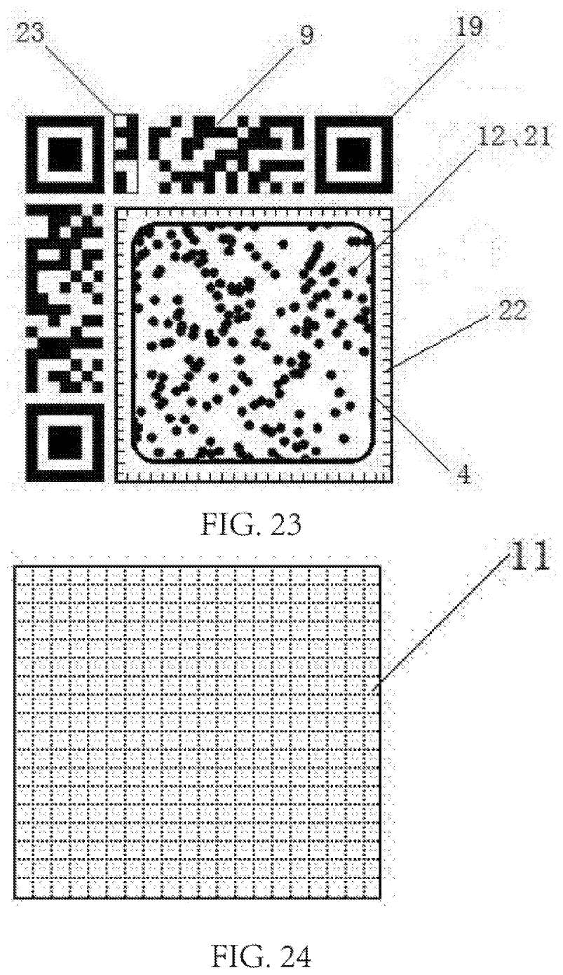

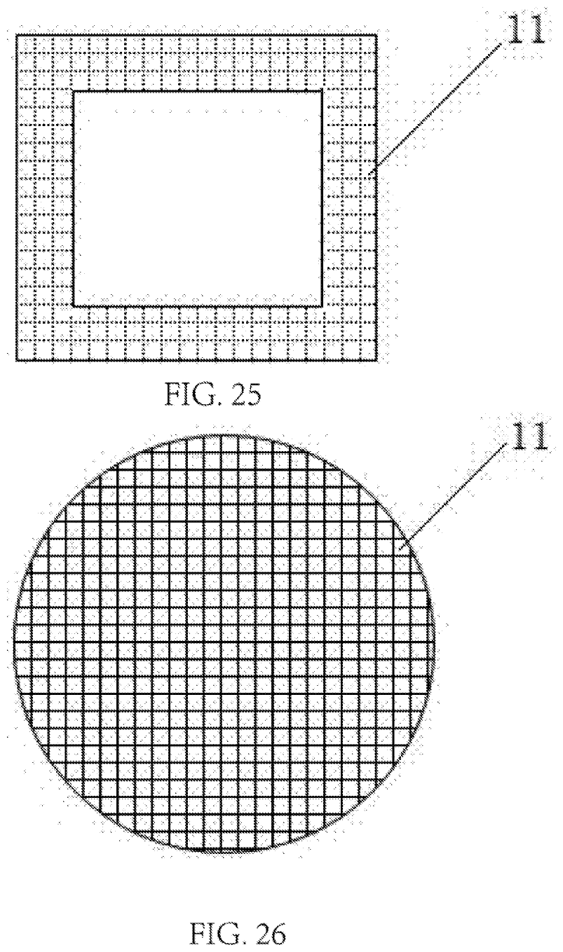

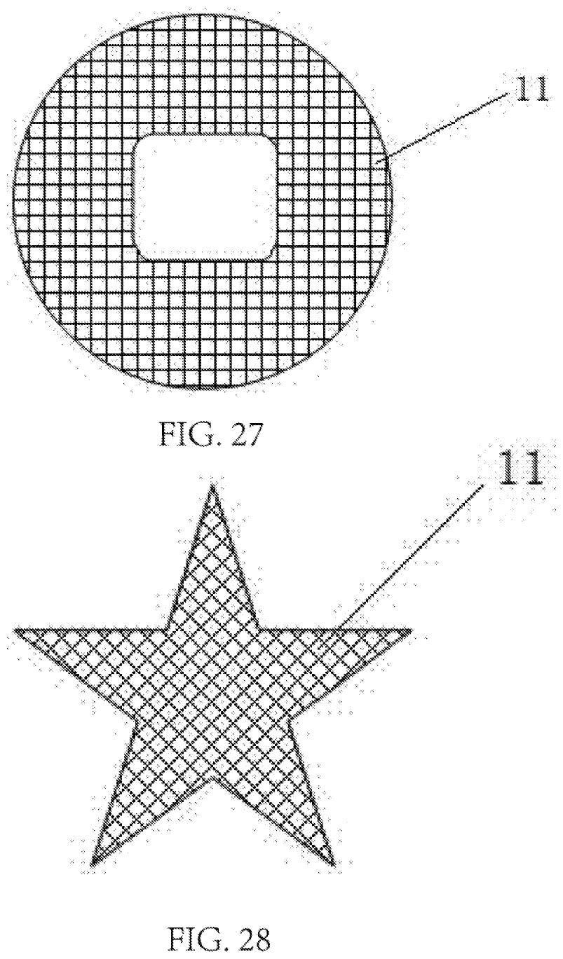

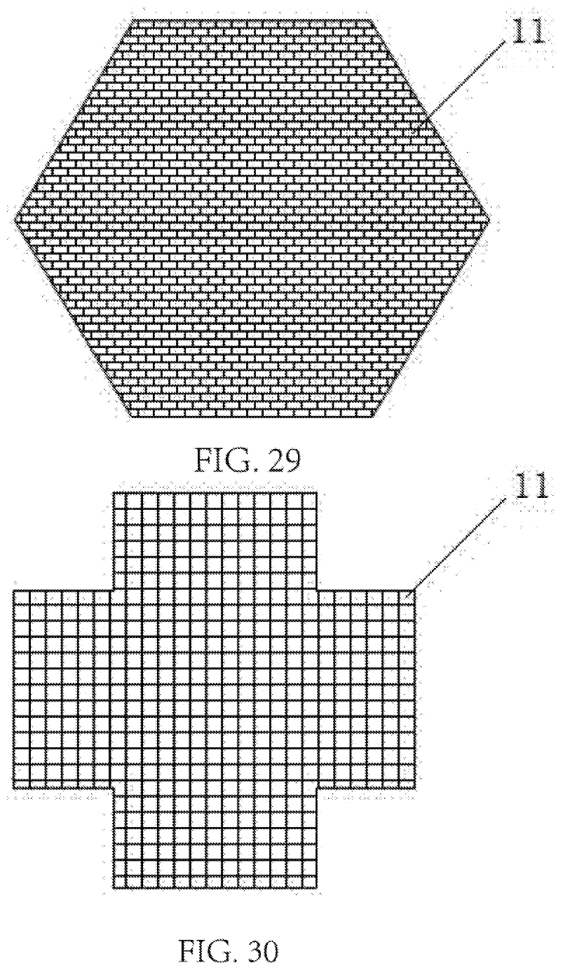

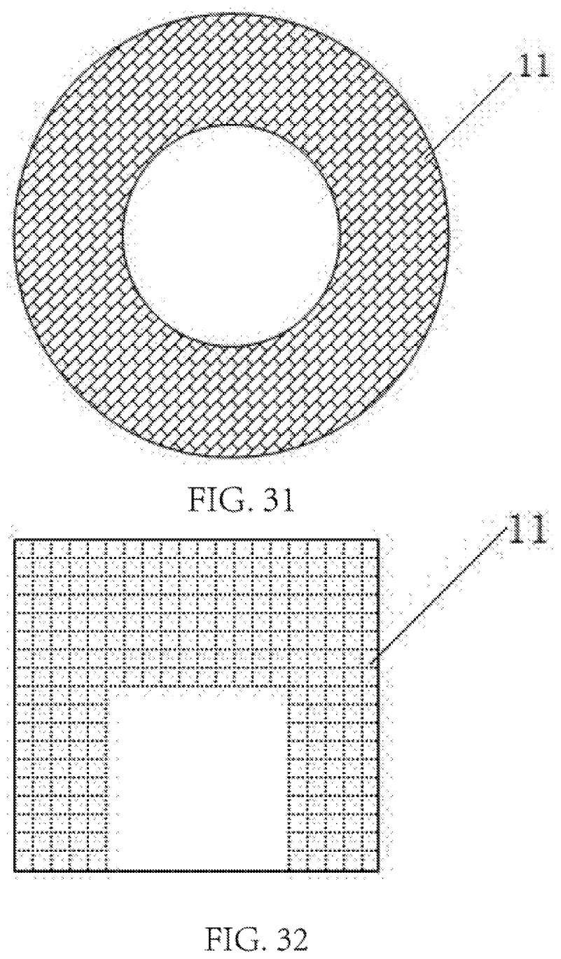

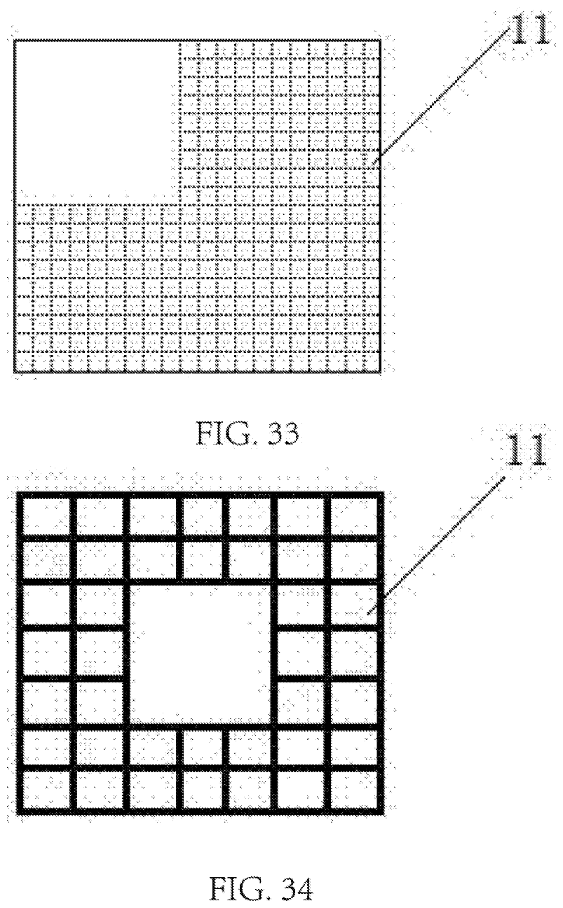

As shown in FIG. 8 and FIG. 23, the personalized feature pattern (4) can be formed by using the current snowflake ink/ice flower ink/glitter ink, etc. ink printing technology. See the Chinese invention patent “UV solidified offset printing snowflake ink (CN103614001A)” for the snowflake printing technology. Since the snowflake printing technology is a frequently-used traditional printing technology at present and belongs to a non-digital printing technology, it will not be repeated here in details. The remaining steps are the same as those in the above four embodiments.

In order to save data storage space, as well as to conduct quick retrieval, all archive photos can be parsed into personalized feature codes (5) respectively according to predetermined rules: for example, by using 9×9=81 virtual feature unit transcoding grids (11), setting that 1 represents black in a feature unit transcoding grid (11), and 0 represents white in it. In this way, some personalized feature codes (5) with high personality may be parsed from some personalized feature patterns (4) with uniform snowflake, but not vice versa. Extreme examples: only 98 binary 1 can be parsed from the pure black personalized feature patterns (4) without snowflake; and only 98 binary 0 can be parsed from the pure white, personalized feature patterns (4) without snowflake. Therefore, from any pattern (such as a leaf, a piece of paper printed with text, a local current two-dimensional code pattern, a business card, a registered trademark, an autograph, a spray-printed production date, a person portrait, etc.), corresponding personalized feature codes (5) can be parsed according to predetermined rules in the present invention.

### Embodiment 6

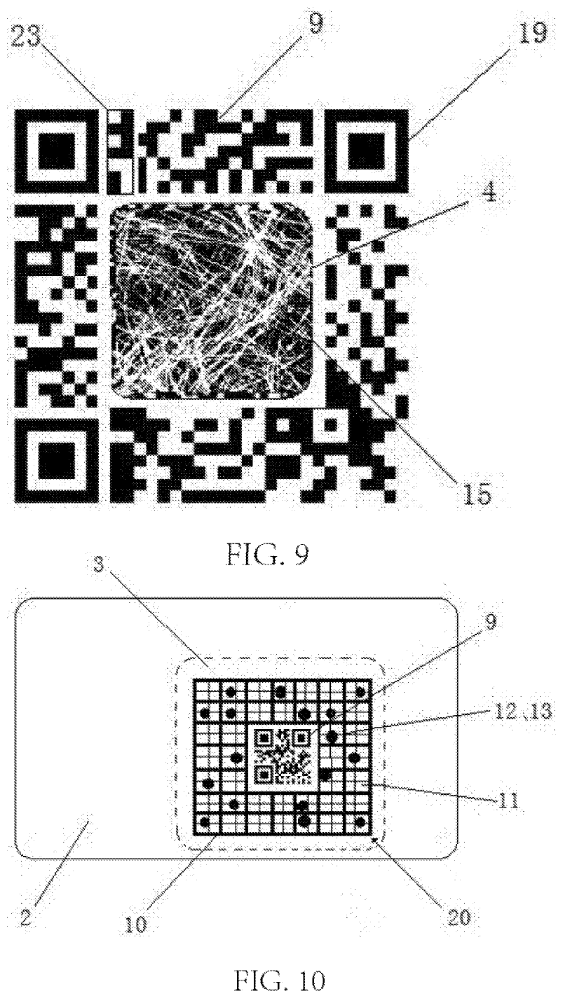

As shown in FIG. 9 the personalized feature pattern (4) can be formed by printing with the current texture paper using a partial covering technology.

See the Chinese utility model patent “structural texture anti-fake printed matter (authorized announcement No.: CN2365711Y) and, the Chinese invention patent “coating-fiber (i.e. texture) color fiber paper (CN105603825A)” for the texture pattern (also known as random spot distribution pattern) and application thereof. Since the texture paper printing technology is a mature printing technology at present, it will not be repeated here in details. The remaining steps are the same as those in the above five embodiments.

### Embodiment 7

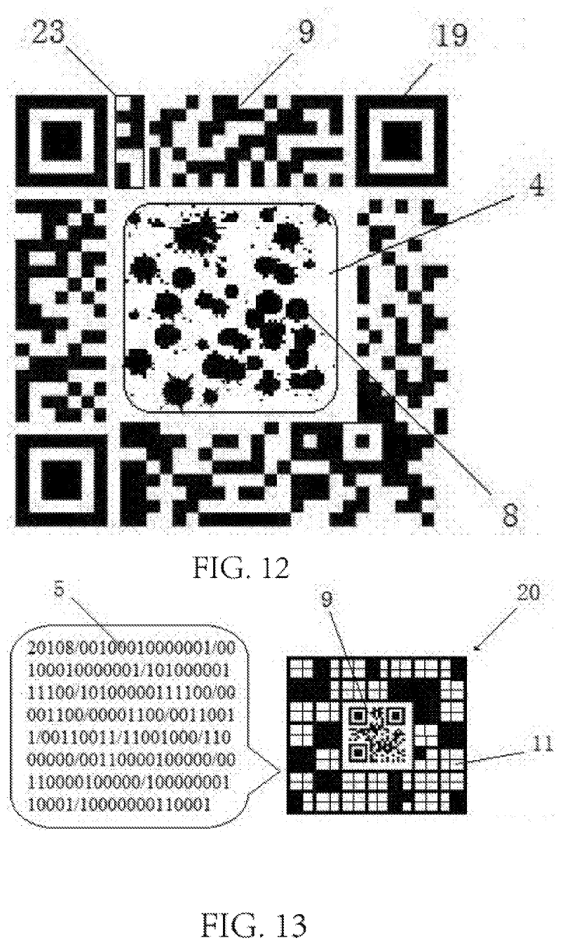

As shown in FIG. 12, the personalized feature pattern (4) can be formed by spraying using the spraying technology for spraying ink. Since the technology is a frequently-used traditional printing technology at present and belongs to a non-digital printing technology, it will not be repeated here in details. The remaining steps are the same as those in the above six embodiments.

### Embodiment 8

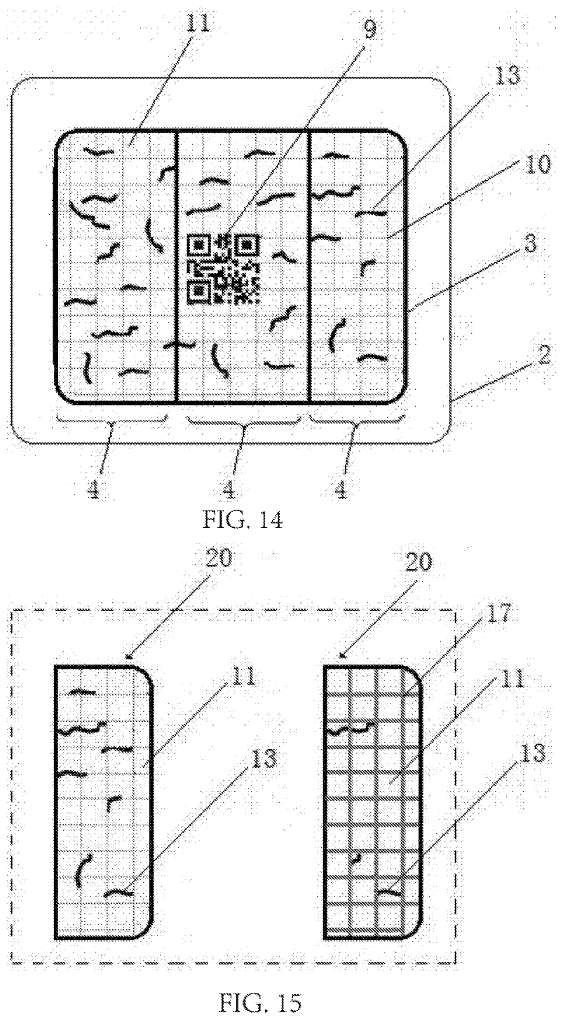

The manufacturer revises and prints the personalized feature pattern (4) in FIG. 5 into left, middle and right subareas as shown in FIG. 14. In this way, there are left, middle and right personalized feature patterns (4) on the same commodity (2).

The manufacturer photographs multiple personalized feature patterns (4), and stores the identified multiple personalized feature codes (5) and the commodity codes (1) respectively into the preset database (16) of the server (6) on the communication network (24) in a one-to-one correspondence mode.

When the user scans the multiple personalized feature patterns (4) simultaneously or separately with the client (7), multiple personalized feature codes (5) can be parsed and sent to the server (6).

The server (6) can retrieve multiple results based on the multiple personalized feature code (5), and feed back the commodity code to the client (7) as a correct result if most of the results are identical and are the same commodity code (1); and can prompt the user for an error if most of the results are different.

As in this embodiment. the same personalized feature pattern (4) in FIG. 5 can also be parsed into multiple personalized feature codes (5) according to different predetermined rules, for example, according to the predetermined rules such as different gray thresholds, different number of feature units and feature units at different locations, and then, the multiple personalized feature codes (5) and respective commodity codes (1) can be stored into the database (16) of the server (6) in a one-to-one correspondence mode.

When retrieving the same commodity code (1) based on the multiple personalized feature code (5), the server (6) can feed back the commodity code (1) to the client (7) as a correct result, and can prompt the user for an error if most of the retrieved results are different. In this way, the scan code misreading rate can be reduced, and the accuracy rate of acquiring the commodity code (1) by scanning code can be increased. In other words, the error-correcting capacity or fault tolerance rate of acquiring the commodity code (1) by scanning code can be increased.

### Embodiment 9

The manufacturer photographs one personalized feature pattern (4) in the right subarea in FIG. 14, the photo photographed is as shown in the left photo in FIG. 15.

When the photo is parsed, the grid line of the image transcoding coordinate (10) in the left photo can be widened into a wide grid line 1 with a width of 1 mm, as shown in the right photo in FIG. 15.

In this way, grid lines of different widths may form virtual feature unit transcoding grids (11) of different sizes. When the user scans and parses the personalized feature pattern (4) using the client (7), the client (7) can parse the photo according to the grid lines of two widths-that is, virtual feature unit transcoding grids (11) of different sizes (equivalent to using two different predetermined rules).

In this way, using two different predetermined rules, two different results can be parsed for the, same personalized feature image (20). The personalized feature codes (5) of the left photo and the right photo are:

69008980001/1100000011001110101000100000110011100000 and 69008980001/000000001100000000000000000010000100000. Since they are a pair of critical codes, they are called a pair of critical personalized feature codes (5) in the present invention.

In this way, multiple critical personalized feature codes (5) can be assigned with the same commodity code (1); and when the user retrieves the commodity code (1) according to any of the multiple critical personalized feature codes (5), the commodity code can be fed back to the client (7) as a correct commodity code (1). In this way, the scan code misreading rate can be reduced, and the accuracy rate of acquiring the commodity code (1) by scanning code can be increased.

### Embodiment 10

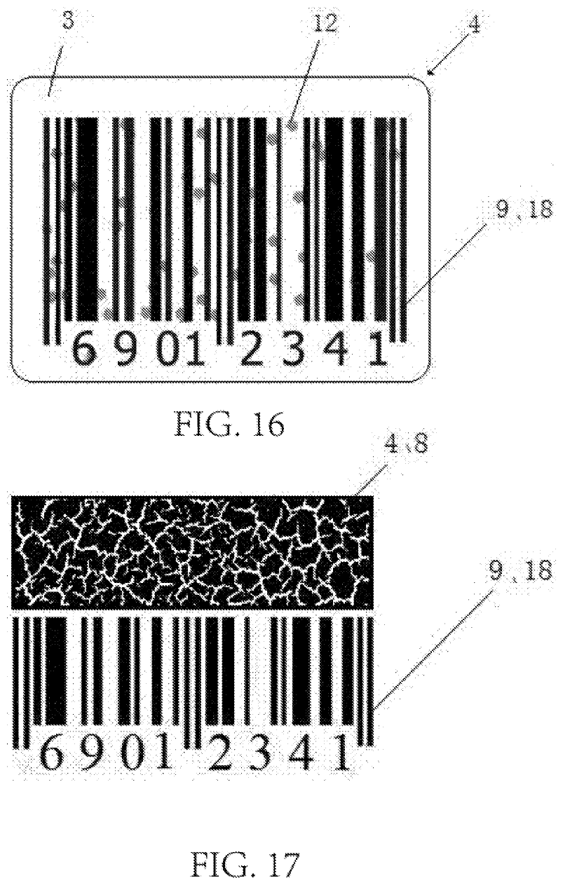

As shown in FIGS. 16, 17 and 18, the present invention is used in, combination with the current commodity bar code (18).

The commodity bar code (18) is a one-dimensional commodity bar code (18), formulated by the EAN International (EAN) and the Uniform Code Council (UCC), used to identify commodity codes, including EAN commodity bar codes (EAN-13, EAN-8) and UPC commodity bar codes (UCC-A, UCC-E) which are frequently used. The commodity bar code (18) described in the National standard of the People's Republic of China GB12904-2003 is a one-dimensional bar code composed of multiple bars (modules) and multiple bar spaces (modules) arranged in parallel. Generally, the commodity bar code (18) of each commodity is unique, that is, a batch of commodities with the same characteristics such, as name, package, trademark, specification, weight, quality and so on share the same one-dimensional commodity bar code (18).

For an ordinary one-dimensional commodity bar code (18), a correlation between the bar code and commodity information is required to be established through a database, and when the data of the bar code is uploaded to a computer, the data is operated and processed by application software of the computer. Therefore, the ordinary one-dimensional commodity bar code (18) is only used as identification information during use, and the meaning thereof is achieved by extracting corresponding information from the database of the computer system. The code system of the frequently-used one-dimensional codes includes: LAN Code, Code 39, interleaved 2 of 5 Code, UPC Code, Code 128, Code 93, ISBN Code, etc. The current anti-fake, logistics, lottery draw trace and other applications require that one item shares one code, that is, each commodity shares a unique code alone. Due to the one-dimensional bar code encoding capacity, each commodity bar code described in GB12904-2003 represents a kind of commodities, that is, a kind of (i.e. tens of thousands of) products share one code rather than one product shares one code alone.

As shown in FIG. 16, a certain commodity (2) is selected, and the, position of the commodity bar code (18) on the package thereof is set as a personalized feature area (3). A red glitter (12) layer is thermoprinted in the area in advance using the current traditional thermoprinting machine. The required thermoprinting film of glitter (12) is a current printing consumable, and is a mature and frequently-used product, referring to the Chinese utility model patent “non-positioning associated code thermoprinting film and thermoprinting marker thereof (CN202156122U)”, and the thermoprinting film is available from the market.

A batch of (for example, 100,000) same commodity bar codes (18), for example, commodity bar codes (18) representing 69012341 are printed on the glitter (21) layer using the current offset printing machine and other traditional forme-based printing machine.

If the annual output of the commodities (2) is low, i.e. less than 100,000, the 100,000 commodities can be assigned with the same group number (9) and equal to commodity bar codes (18) without grouping. In this way, each commodity (2) has a personalized feature pattern (4), which is unique within the range of 100,000 commodities and is composed of randomly distributed glitter (12) and commodity bar codes (18).

In printing production, the printing plant uses the current product inspection machine to photograph the personalized feature image (20) of each commodity (2).

Based on the steps described in the above embodiment, the parsing software is used to conduct binarization processing on the photographed black and white image (as shown in FIG. 19) according to the predetermined rule, and then parse the respective personalized feature codes (5). For example, by assigning virtual lines or grids, the personalized feature image (20) in FIG. 16 is converted into the personalized feature image (20) shown in FIG. 19, and the 21 white seams are all divided into 4 sections with wide grid lines (17), so that the personalized feature pattern (4) is divided into 4×21 feature unit transcoding grids (11). It is set that 1 represents that there are glitter (12) in the feature unit transcoding grid (11) (no matter how many) and 0 represents that there is no glitter (12) (i.e. space)in the feature unit transcoding grids (11), and, the following binary personalized feature code (5) is parsed according to the sequence from left to right and from top to bottom:

1100100010000111100010110100011001010000001100101010011110001001101010111 01011000000. The binary personalized feature code (5) is converted into a hexadecimal personalized feature code C8878B465032A789. The test experiment indicates that for the 100,000 commodities (2) generated by code assignment, the probability of duplicate numbers of the 100,000 personalized feature codes (5) parsed according to predetermined rules is less than 1 in 267. Such low probability of duplicate numbers can fully meet the requirement of the customer that the commodity code (1) must have uniqueness.

In order to facilitate the user to, use according to the idiom of the current commodity code (1), the above-mentioned 100,000 personalized feature codes (5) can be respectively assigned with a 5-digit current commodity code (1), for example, No.10009 according to the production time sequence and stored them into the preset database (16) in a one-to-one correspondence mode.

In this way, when a consumer is shopping in the supermarket, the cashier can use the client (7) provided with predetermined rule analysis software to scan the commodity bar code (18) for checking out and incidentally obtain the commodity code (1), for example No. 10009. Thus, the commodity code (1) is incidentally printed on the shopping receipt.

In this way, when a consumer scans a code for shopping in the supermarket or scans a code for price comparison using a mobile phone, the parsing software can incidentally feed back (collect) the big data for commodity circulation such as redemption numbers, traceability codes, logistics codes, product serial numbers, (milk) organic codes, etc. long-cherished by the manufacturers according to predetermined rules. Analyzing and using these big data have huge market value, for example, supermarkets can use these big data to conduct goods return and exchange management, and manufacturers can use these big data to conduct anti-channeling management.

In this embodiment, the fixed commodity bar code (18) printed by the current traditional technology and the commodity code (1) parsed from the personalized feature pattern (4) printed by the traditional technology are integrated into one. Of course, when there are a large number of commodities (2), on the basis of the current commodity code (1), the capacity of the commodity code (1) can be increased by increasing the number of digits or complex software to guarantee the uniqueness of the commodity code (1).

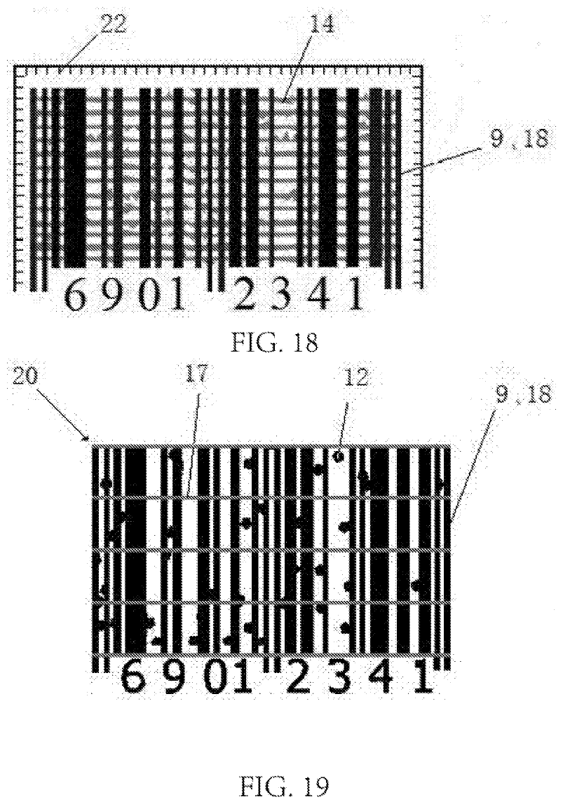

As described in this embodiment, referring to FIG. 17 and FIG. 18, personalized feature patterns (4) such as light-color ink cracks or light-color sawteeth or the like may be printed using the traditional forme-based printing machine, and the commodity bar code (18) is kept black. The digital photos photographed are parsed into personalized feature codes (5), the personalized feature codes (5) and other personalized feature information are assigned with a commodity code (1) and recorded in the preset database (16), so that each commodity (2) and the commodity bar code (18) have a unique commodity code (1), to facilitate the user to scan the commodity code (1) using the client (7) and use the commodity code (1) to conduct various applications.

In order to facilitate the client (7) to parse the personalized feature pattern (4) and commodity bar code (18) according to a predetermined rule, as shown in FIG. 18, it is better to print a graduated scale (22) on the commodity bar code (18).

The above ten embodiments enumerate some cases of generating personalized feature patterns (4) which are equivalent to the fingerprints of commodities (2). In production practice, cases of a variety of process technologies for forming personalized feature patterns (4) (including technologies to be newly developed in the future) are too numerous to mention individually, and these cases fully demonstrate that the traditional printing machine and printing technology thereof can naturally form personalized feature (two-dimensional) patterns (4)-equivalent to natural two-dimensional code patterns. The personalized feature codes (5) parsed from the personalized feature pattern (4) according to the predetermined rules, equivalent to information recorded in natural two-dimensional codes, can be assigned with commodity codes (1) required by a large number of commodities (2), thereby avoiding using a digital printing machine to print commodity codes (1). The present invention not only can save the investment of code assignment devices, but also can improve code assignment speed, reduce code assignment costs and guarantee code assignment quality.

For the two-dimensional codes of group numbers (9) in FIG. 8, FIG. 9, FIG. 11, FIG. 12 and FIG. 23 above, because the central area is largely occupied, the group numbers (9) cannot be identified and read by the current QR two-dimensional code scanning, software. In order to identify the group numbers (9), custom two-dimensional code scanning software and parsing rules may be used, for example, custom two-dimensional code scanning software capable of parsing personalized feature codes (5) from personalized feature the pattern (4).

### Embodiment 11

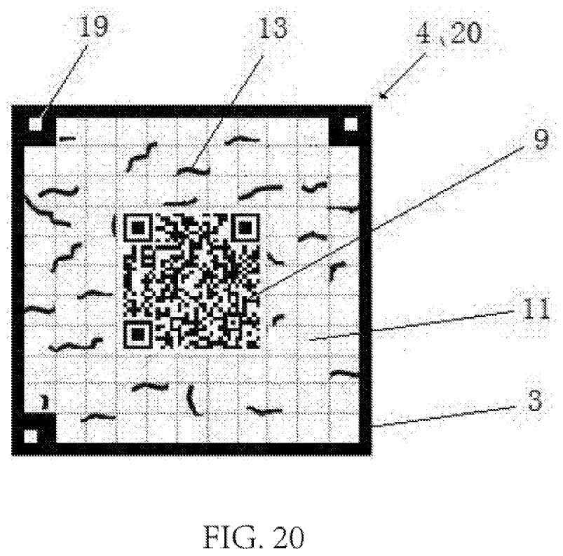

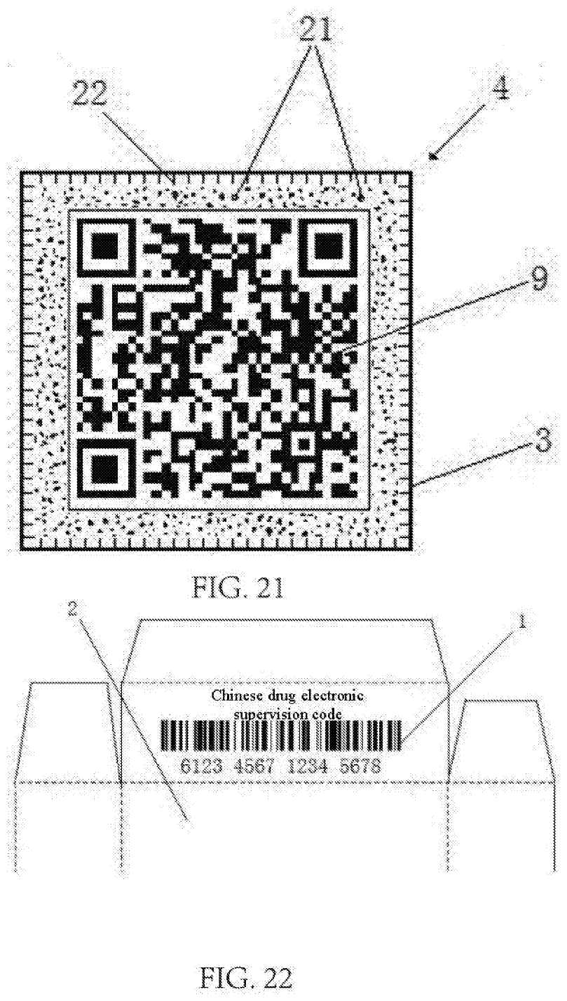

As shown in FIG. 20, if a sanitary napkin manufacturer needs to assign total 500 million bags of sanitary napkin commodities (2) with codes, each bag of sanitary napkin commodity (2) is assigned with at least one unique commodity code (1) , for example, 124333276225/000001, 124333276225/000002, 124333276225/000003, 124333276225/000004 . . . n, etc. There is no need to print the commodity code (1) on the bag. Every 100,000 bags are divided into one group, and each group is assigned with a unique group number (9). The group number (9) is printed on the, bag in the form of a 11 mm×11 mm fixed QR two-dimensional code. In this way, 5 billion bags can be assigned with 5000 different group numbers (9), for example, group numbers containing the commodity (2) information link URL: http://ppk365.com/124333276225, http://ppk365.com/124333276226, http://ppk365.com/124333276227, etc. Of course, the webpage URL information can also be directly used as a group number (9).

Printing personalized feature patterns: circling a 18 mm×18 mm area on the bag film as a personalized feature area (3), printing a 11 mm×11 mm fixed QR two-dimensional code group number (9) in the middle position of the area, and printing 92 grid-shaped feature unit transcoding grids (11) around the two-dimensional code. The grid-shaped feature unit transcoding grids (11) are printed with a blue dotted line, and the size of each, of the length and width of each feature unit transcoding grid (11) is set to 1 mm×1 mm.

By using “local large-size fiber letterpress printing system and printed matter thereof” (authorized announcement No.: CN103042814B) and CN206322415U and other patent technologies to print feature unit transcoding grids (11), fixed QR two-dimensional code group numbers (9) and, ink (8) mixed with black fibers (13) 0.2-1.6 mm in length on the bag film, the multiple black fibers (13) randomly distributed in the ink (8) layer in the personalized feature area (3) form a personalized feature pattern (4).

Collecting personalized feature information: photographing the feature unit transcoding grid (11), QR two-dimensional code group number (9) and personalized feature pattern (4) randomly formed by multiple fibers (13) on each bag by a digital camera, and storing all 500 million digital photos, that is, personalized feature images co into the preset database (16) according to the group numbers (9).

In order to save data storage space, as well as to conduct quick retrieval, all archive photos-personalized feature images (20) can be parsed into personalized feature codes (5) respectively according to predetermined rules. As shown in FIG. 20, a predetermined rule is formulated: by using 92 grid-shaped feature unit transcoding grids (11), setting that 1 represents that there are fibers (13) in the feature unit transcoding grids (11) (no matter how many); setting that 0 represents that there is no fiber (13) in a single feature unit transcoding grid (11); and encoding and parsing according to the arrangement sequence from left to right and from top to bottom. Thus, the two-dimensional code representing the group number (9) and personalized feature pattern (4) shown in FIG. 20 may be parsed into group numbers (9) and personalized feature codes (5):

124333276225/100101100/00011100000/11001101110/111010/010111/101001/110100/111000/00000000001/10011101100/1100001000 (16hexadecimal, represented 1CF2D73C41/ 960E0CDDD2F4E9C0). 124333276225 is the, group number (9) digit scanned from the two-dimensional code group number (9).

All the 100,000 digital photos photographed and collected are assigned with commodity codes (1) containing group numbers (9). Preferably, all the digital photos photographed are parsed into personalized feature codes (5) according to predetermined rules, and are assigned with commodity codes (1) containing group numbers (9) according to the real production sequence of commodities (2) on the assembly line. Assuming that the real production sequence of the commodities (2) in FIG. 20 on the assembly line of a manufacturer is No. 000003 of a certain year, month, day, after being assigned with, a commodity code (1) 000003 containing a group number (9), the personalized feature code (5) thereof is correspondingly stored as 1CF2D73C41/000003/960E0CDDD2F4E9CO, where 1CF2D73C41/000003 represents the commodity code (1), and 960E0CDDD2F4E9C0 represents the personalized feature code (5).

Of course, all the digital photos photographed-personal characteristic images (20) can be named directly with the commodity code (1) containing the group number (1) as the image file name thereof, and stored into the preset database (16) of the server (6) connected to the communication network (24).

If a consumer, merchant or business management staff needs to trace logistics information such as the source of feminine napkin, taking a photo (including video) for the group number (9) and personalized feature pattern (4) on the feminine napkin bag with a smart phone and uploading same to the server (6), and parsing corresponding personalized feature codes (5) and group number (9) data from the uploaded photo by the server (6); for a smart phone user who has downloaded and installed predetermined rule analysis software, using the smart phone as a client (7) to scan, the personalized feature pattern (4), to parse corresponding personalized feature codes (5) and group numbers (9), and uploading the parsed personalized feature codes (5) and group numbers (9) data (for example, 1CF2D73C41/960E0CDDD2F4E9C0) to the server (6);

retrieving a corresponding commodity code (1) (for example, 124333276225/000003) by the, server (6) based on the personalized feature code (5) and the group number (9) (for example, 1CF2D73C41/960E0CDDD2F4E9C0) uploaded by the user through the client (7) or the smart phone, and feeding back the retrieved commodity code (1) to the (user) client (7) or smart phone.

Of course, the server (6) can conduct image identification and retrieve a corresponding image file name, i.e. a commodity code (1) (for example, 124333276225/000003) based on the personalized feature image (20) uploaded by the user, and feed back the retrieved commodity code (1) to the (user) client (7) or smart phone. The image identification technology required herein refers to a technology that uses a computer to process, analyze, and understand images to identify targets and objects in various modes. Since the image recognition technology belongs to an important field of artificial intelligence, and is a relatively mature prior art, it will not be repeated here in details.

As mentioned above, 500 million bags of sanitary napkins are respectively assigned with a commodity code (1) that has uniqueness and sequential and complies with the current encoding rule and standard by printing the personalized feature pattern (4) using a traditional forme-based printing machine, so that tracing, logistics management, marketing rewards, point rewards, and other applications can be conducted by means of the commodity code (1).

As shown in FIG. 20. for a smart phone user who has not downloaded and installed predetermined rule analysis software, he/she can use the WeChat Scan software to scan the personalized feature pattern (4) on the feminine napkin bag, to identify the QR two-dimensional code containing webpage URL information, and open the link to browse the introduction and other information of the commodity (2). Of course, the group number (9) may also function as a webpage URL.

### Embodiment 12

As shown in FIG. 21. referring to the thermochromic principle of the Chinese invention patent “thermochromic paint and carbonless copy paper containing same (CN103603229A)”, some micro capsules encapsulating thermochromic dye (having no influence on ink distribution and printing due to small diameter thereof (about 2-7 μm)) and color developing agent are added to transparent light oil, to, make thermochromic ink; the thermochromic ink is printed in a frame-shaped personalized feature area (3) by means of the forme-based printing technology and dried by heating or dried by UV irradiation; and because the micro capsules may rupture when exposed to heat or ultraviolet light, a thermochromic chemical reaction may occur between the overflowing thermochromic dye and color developing agent around same, forming some randomly distributed thermochromic spots (21) with the diameter enlarged to 0.01-1 mm (much larger than that of the micro capsules). In this way, the randomly distributed thermochromic spots (21) constitute the personalized feature pattern (4) of the present invention.

In order to facilitate the parsing software to find and determine the precise position of the feature unit transcoding grid (11) according to a predetermined rule, a graduated scale (22) is printed at the edge of the personalized feature area (3) in FIG. 21, so that the parsing software generates virtual grid lines or virtual feature unit transcoding grids (11) on the personalized feature image (20) according to the graduated scale (22) to parse personalized feature codes (5). For example: 22×2×4=176 virtual feature unit transcoding grids (11) are generated on the personalized feature image (20) according to the graduated scale (22), each feature unit transcoding grid (11) having an area of 0.5 mm×0.5 mm, it is set that 1 represents that there are thermochromic spots (21) in the feature unit transcoding grids (11), and 0 represents there is no thermochromic spot in a feature unit transcoding grid, and a 176-digit binary personalized feature code (5) is parsed by arranging clockwise around the group number (9) from the outer circle to the inner circle.

In order to facilitate the user to use according to the idiom of the current commodity code (1), the above-mentioned personalized feature codes (5) can be respectively assigned with a commodity code (1) according to the production time sequence and stored into the preset database (16) in a one-to-one correspondence mode.

As shown in FIG. 21, for a smart phone user who has not downloaded and installed predetermined rule analysis software, he/she can use the WeChat Scan software to scan the frame-shaped personalized feature pattern (4) and the group number (9) thereof, to identify the two-dimensional code containing webpage URI, information and open the link to browse the introduction and other information of the commodity (2).

If a merchant or business management staff needs to trace information such, as the source of commodity (2), scanning the group number (9) and personalized feature pattern (4) on the commodity (2) with a client (7) downloaded and installed in the smart phone, parsing corresponding personalized feature codes (5) and group number (9) data, and uploading the parsed personalized feature codes (5) and group number (9) data into the present database (16); and retrieving a corresponding commodity code (1) by the server (6) based on the personalized feature codes (5) and group number (9) data uploaded by the user, and feeding back the retrieved commodity code (1) to the client (7) or smart phone for the user to conduct related applications.

Studies show that it is a preferred solution for printing a personalized feature pattern (4) to use the thermochromic ink in the present embodiment to form the thermochromic spots (21) and the frame-shaped personalized feature pattern (4) thereof, in particular the frame-shaped personalized feature pattern (4) which looks like a decorative frame of a two-dimensional code group number (9), has many advantages such as uniform spots, high uniqueness, simplicity, and adaptability to various printing technologies.

### Embodiment 13

The present embodiment introduces how a user uses the commodity code (1) fed back to the client (7).

The salt commodities (2) in embodiment 1 are still taken as examples. Assuming that every 50 bags of salt commodities are packed in one packing box, a natural order two-dimensional code tag or RFID tag is attached to the outside of each packing box, the box codes of the tag being 00000001, 00000002, 00000003, 00000004 . . . .

When packing, the personalized feature area (3) on each bag of commodity (2) is scanned using the client (7), to acquire the commodity code (1) fed back, by the server (6); and the commodity code (1) belonging to 50 bags of salt commodities (2) in the same packing box is associated with a box code (for example, a certain box code 00000003) and stored into the user's own trace database platform. Further, the box code may be associated with the stack code, so as to conduct informatization management of merchandise (2) such as warehouse-in and warehouse-out receiving and dispatching, and logistics of commodities (2).

Of course, the step of acquiring the commodity code (1) from the server (6) may be omitted, the personalized feature codes (5) of the 50 bags of salt commodities (2) parsed by scanning using the client (7) are directly associated with a box code (a certain box code 00000003) and stored into the user's own trace database platform.

In this way, when dispatching, the user may use a dispatching scanning gun to scan the box code on each box and input, logistics information and trace information about dispatching destination district, consignee and the like in the trace database platform.

In this way, in the event of a quality accident, if there is a need to recall the product, the manufacturer and the government management department can query the trace database platform for the destination and source of each bag of salt commodity (2). Before using, the consumer may use the client (7) to scan the personalized feature area (3) on the bag of the salt commodity (2), to acquire information whether the salt commodity belongs to a product to be recalled

### Embodiment 14

Based on the embodiment, the present invention further provides a corresponding personalized pattern-based commodity virtual code assignment system, which can be used to execute the above-mentioned method and comprises the following parts:

\textcircled{1} personalized feature pattern printing equipment, used to set a personalized feature area (3) on the commodity (2) and print naturally formed and visible random dots or/and lines or/and planes to form at least one random personalized feature pattern (4) which is unique within the predetermined number on each commodity (2):

\textcircled{2} a personalized feature information collection device, used to photograph the personalized feature pattern (4) on the commodity (2) to obtain a random personalized feature image (20) which is unique within the predetermined number;

\textcircled{3} a parsing software readable memory, used to store predetermined rule parsing software, wherein when being executed by the processor, the parsing software parses random personalized feature codes (5) of each commodity (2) which are unique within the predetermined number based on the personalized feature image (20);

\textcircled{4} a user client (7), comprising a scanning device and a parsing device,

wherein the scanning device is used to scan the, personalized feature pattern (4) on the commodity (2);

and the parsing device is used to parse the scanned personalized feature pattern (4) to acquire a personalized feature code (5) and upload the personalized feature pattern (4) and/or the personalized feature code (5) to the server (6) as the, personalized feature information;

\textcircled{5} a server (6), comprising -a data memory, a communication module and a retrieval device,

wherein the data memory is used to back up and store the personalized feature image (20) and/or the personalized feature code (5) parsed based on the personalized feature image (20), and associate and store at least one unique commodity code (1) of, each commodity (2) and the personalized feature image (20) used as personalized feature information and/or the parsed personalized feature code (5);

the communication module is used to communicate with the client (7) so as to receive the information uploaded from the client (7) or send information to the client;

and the retrieval device is used to retrieve the commodity code (1) in the data memory based on some or all of the personalized feature information when the communication module receives the personalized feature information, and to send the retrieved commodity code (1) to the client (7) through the communication module or send the information about commodities to the client (7).

The above embodiment of the present invention enumerates some specific implementation cases. In practice, according to a variety of different printing technologies such as offset printing technology, flexo printing technology, gravure printing technology, screen printing technology. thermoprinting technology, pad printing technology, spraying printing technology, etc., personalized feature patterns (4) are printed and commodity codes (1) are associated to achieve virtual code assignment of commodities (2).

The key to the quality of the implementation of the present invention is whether it is possible to print a personalized feature pattern (4) with obvious personalized features. With the further application, in order to obtain a personalized feature pattern (4) with obvious personalized features, more suitable ink and printing technology capable of naturally forming the personalized feature pattern (4) can be continuously developed and sought.

In order to obtain better user experience, the predetermined rule parsing software of the client (7) can be continuously perfected, and upgraded, so that the client (7) can scan the personalized feature pattern (4) and obtain the commodity code (1) faster and more accurately.

The above revealed content is just one preferred embodiment of the present invention and is certainly not, intended to define the scope of rights of the present invention. Therefore, all equal modifications made in accordance with claims of the present invention shall still belong to the scope covered by the present invention.

1. A personalized pattern-based commodity virtual code assignment method, characterized by comprising:
\textcircled{1} printing personalized feature patterns—
setting a personalized feature area (3) on a commodity (2) and printing visible random dots or/and lines or/and planes in the personalized feature area (3) to form at least one random personalized feature pattern (4) which is unique within the predetermined number on each commodity (2);
\textcircled{2} collecting personalized feature information—
photographing the personalized feature pattern (4) on the commodity (2) to obtain a random personalized feature image (20) which is unique within the predetermined number;
or/and, photographing the personalized feature pattern (4) on the commodity (2), and according to a predetermined rule, parsing a random personalized feature code (5) of each commodity (2) which is unique within the predetermined number from the personalized feature pattern (4) or the personalized feature image (20);
\textcircled{3} backing up the personalized feature information—
backing up and storing the photographed personalized feature image (20) or/and the parsed personalized feature code (5) into the preset database (16); or, assigning at least one unique commodity code (1) to each commodity (2), and associating and storing the commodity code (1) and the personalized feature information into the preset database (16) instead of printing the commodity code (1) on the commodity (2);
\textcircled{4} parsing and accessing the commodity code—
when a user needs to use the commodity code (1), scanning the personalized feature pattern (4) on the commodity (2) with a client (7), parsing the personalized feature code (5) from the personalized feature pattern (4) with the client (7) according to the predetermined rule, and using the personalized feature code (5) as the commodity code (1) of the scanned commodity (2); or, when a user needs to use the commodity code (1), scanning the personalized feature pattern (4) on the commodity (2) with a client (7), uploading the personalized feature information with the client (7), and after a server (6) receives the personalized feature information uploaded from the client (7) retrieving the associated commodity code (1) from the preset database (6) according to the personalized feature information and feeding back to the client (7).

2. The personalized pattern-based commodity virtual code assignment method according to claim 1, characterized by comprising at least one of the following:
\textcircled{1} naturally formed random dots or/and lines or/and planes are printed in the personalized feature area (3) with the forme-based printing process or spraying process to form the personalized feature pattern (4);
\textcircled{2} the predetermined number is n, and commodities (2) are divided into groups with n commodities (2) in each group, wherein 100≤n≤100,000, or 100,000≤n≤1,000,000, or 1,000,000≤n≤10,000,000, or 10,000,000≤n≤100,000,000;
each group of commodities (2) is assigned with at least one unique group, number (9), and a fixed code segment in the commodity code (1) is used as the group number (9) and printed in the, personalized feature area (3); and the personalized feature image (20) or personalized feature code (5) of the same group of commodities (2), which is stored on the server (6), is assigned with the same group number (9);
\textcircled{3} randomly distributed colored fibers (:3) are arranged in the personalized feature area (3), and the random distribution pattern of the colored fibers (13) forms at least one part of the personalized feature pattern (4) of each commodity (2);
or, random sawteeth (14) are naturally formed at the edges of the ink dots or/and lines or/and planes in the personalized feature area (3), and the sawteeth (14) form at least one part of the personalized feature pattern (4) of each, commodity (2);
or, random textures (15) are naturally formed in the personalized feature area (3), and the random textures (15) form at least one part of the personalized feature pattern (4) of each commodity (2);
or, snow/ice flowers are naturally formed in the personalized feature area (3), and the snow/ice flowers form at least one part of the personalized feature pattern (4) of each commodity (2);
ED image transcoding coordinates (10) or/and feature unit transcoding grids (11) conforming to the predetermined rule are printed in the personalized feature pattern (4); or, the personalized feature code (5) is parsed from the personalized feature image (20) with the virtual image transcoding coordinates (10) or/and feature unit transcoding grids (11);
\textcircled{5} X feature unit transcoding grids (11) are printed on the personalized feature pattern (4); and personalized features in the feature unit transcoding grids (11) are respectively expressed by different characters according to the predetermined rule to parse the corresponding personalized feature code (5) from the personalized feature pattern (4) according to the predetermined rule;
\textcircled{6} the ratio of the code length of the commodity code (1) to the code length of the corresponding personalized feature code (5) is ≤0.5, or ≤0.3, or ≤0.1, or ≤0.01;
\textcircled{7} the commodity code (1) is associated with the personalized feature code (5) or/and personalized feature image (20) of each commodity (2) according to the real production sequence of the commodities (2) on the assembly line;
\textcircled{8} positioning patterns or/and position detection patterns (19) are printed in the personalized feature area (3);
\textcircled{9} a graduated scale (22) is printed in the personalized feature area (3) or at the edge thereof ;
\textcircled{10} the personalized feature pattern (4) comprises a pattern consisting of randomly distributed thermochromic spots (21);
\textcircled{11} multiple different personalized feature codes (5) are respectively parsed according to multiple predetermined rules based on the same personalized feature pattern (4); and the multiple different personalized feature codes (5) are associated with the same commodity code (1) and stored into the preset database (18);
\textcircled{12} multiple personalized feature codes (5) are respectively parsed according to multiple different predetermined rules based on the same personalized feature image (20); and after the same commodity code (1) is retrieved according to the multiple personalized feature codes (5), the commodity code (1) is fed back to the client (7);
\textcircled{13} multiple personalized feature patterns (4) are arranged in the same personalized feature area (3) on the same commodity (2); multiple personalized feature codes (5) are respectively parsed: the multiple personalized feature codes (5) are assigned to the same commodity code (1); and among multiple commodity codes (1) retrieved according to the multiple personalized feature codes (5), the same commodity codes (1) are fed back to the client (7);
\textcircled{14} the same personalized feature image (20) is assigned with virtual, feature unit transcoding grids (11) of different sizes, and multiple critical personalized feature codes (5) are parsed according to the predetermined rule; the multiple critical personalized feature codes (5) are assigned to the same commodity code (1); and after the commodity code (1) is retrieved according to any of the multiple critical personalized feature codes (5), the commodity code (1) is fed back to the client (7);
\textcircled{15} a commodity bar code (18) is arranged in or near the personalized, feature area (3) on the commodity (2), the personalized feature pattern (4) on the commodity (2) is scanned, and the personalized feature code (5) of the scanned commodity (2) is parsed according to the predetermined rule; and the corresponding commodity code (1) is retrieved from the preset database (16) according to the personalized feature code (5);
\textcircled{16} when the personalized feature image (20) is parsed at a certain parsing precision and the personalized feature code (5) is found to have duplicate numbers, another predetermined rule is enabled to parse the personalized feature image (20) at a higher parsing precision, and another parsed personalized feature code (5) is backed up into the preset database (16) as a check code;
\textcircled{17} when the personalized feature area (3) containing the group number (9) is scanned and parsed on the client (7) and the group number (9) is parsed, a sound/light prompt is sent to inform'the user of successful scanning, and the scanned personalized feature image (20) is reserved;
\textcircled{18} when the personalized feature information is collected and the latter personalized feature code (5) and another preceding personalized feature code (5) within the same group number have duplicate numbers, the personalized feature image (20) corresponding to the personalized feature code (5) is added to the preset database (16);
\textcircled{19} the client (7) is a smart phone, or a smart, phone or other terminal equipment installed with parsing software executing the predetermined rule;
\textcircled{20} the fixed code segment of the commodity code (1) is not printed on the commodity (2).

3. The personalized pattern-based commodity virtual code assignment method according to claim 1, characterized by comprising at least one of the following:
\textcircled{1} the predetermined number is n, the personalized feature pattern (4) or the personalized feature image (20) is divided into x feature unit transcoding grids (11), and the predetermined number n of each group of commodities (2) is less than or equal to 2x/100,000;
or, the predetermined number n of each group of commodities (2) is less than or equal to 2x/1,000,000;
or, the predetermined number n of each group of commodities (2) is less than or equal to 2x/10,000,000;
or, the number repetition rate of the personalized feature code (5) within the same group number (9) is less than 1/100,000;
\textcircled{2} the personalized feature pattern (4) or the personalized feature image (20) is divided into x feature unit transcoding grids (11), wherein x≤15 or 30 or 60 or 120 or 240 or 480 or 960 or 1,500 or 3,000;
\textcircled{3} each feature unit transcoding grid (11) has an area of s(mm2), wherein 0.05×/0.05≤s≤2×2, or 0.05×0.05≤s≤1.5×1.5, or 0.05×0.05≤s≤1×1, or 0.05×0.05≤s≤0.5×0.5, or 0.05×0.05≤s≤0.25×0.25, or 0.05×0.05≤s≤0.1×0.1;
\textcircled{4} the group number (9) comprises the link URL of the commodity (2) information; or, the group number (9) is the two-dimensional code of an applet of WeChat;
\textcircled{5} the group number (9) and the personalized feature pattern (4) in the personalized feature area (3) on the commodity is scanned with the client (7), and the group, number (9) data and the personalized feature code (5) are parsed by the client (7) from the group number (9) and the personalized feature pattern (4) according to the predetermined rule;
\textcircled{6} the diameter/width of each visible clot/line is great than or equal to 0.05 mm;
\textcircled{7} the commodity code (1) is split into a fixed code segment and a variable code segment, wherein the fixed code segment is printed in the personalized feature area (3) on the commodity (2), and the variable code segment is, not printed on the commodity (2);
\textcircled{8} the commodity code (1) is not fully printed on the commodity (2), and only the local code segment is printed on the commodity (2);
\textcircled{9} the personalized feature pattern (4) is dried and cured to be stable and unchanged;
\textcircled{10} the x feature unit transcoding grids (11) are arranged into a grid shape;
\textcircled{11} the template number (23) of the feature unit transcoding grids (11) is printed in the personalized feature area (3) for the client (7) to invoke the feature unit transcoding grids (11) of the corresponding template during parsing and scanning to parse the personalized feature code (5);
\textcircled{12} the personalized feature codes (5) or/and the commodity codes (1) of a plurality of commodities (2) in the same packing unit are associated:
\textcircled{13} the area of the personalized feature area (3) is 8 mm×8 mm to 48 mm×48 mm;
\textcircled{14} the template number (23) is the local code segment within the group number (9).

4. A personalized pattern-based commodity virtual code assignment system, characterized by comprising:
\textcircled{1} personalized feature pattern printing equipment, used to set a personalized feature area (3) on the commodity (2) and print naturally formed and visible random dots or/and lines or/and planes to form at least one random personalized feature pattern (4) which is unique within the predetermined number on each commodity (2);
\textcircled{2} a personalized feature information collection device, used to photograph the personalized feature pattern (4) on the commodity (2) to obtain a random personalized feature image (20) which is unique within the predetermined number;
\textcircled{3} a user client (7), comprising a scanning device which is used to scan the personalized feature pattern (4) on the commodity (2) and upload the personalized feature pattern (4) to the server (6) as the personalized feature information;
\textcircled{4} a server (6), comprising a data memory, a communication module and a retrieval device, wherein the data memory is used to back up and store the personalized feature code (5) and associate and store at least one unique commodity code (1) of each commodity (2) and the personalized feature pattern (4) used as the personalized feature information; the communication module is used to communicate with the client (7) so as to receive the, information uploaded from the client (7) or send information to the client (7); and the retrieval device is used to retrieve the commodity code (1) in the data memory based on, the personalized feature information when the communication module receives the personalized feature information, and to send the retrieved commodity code (1) to the client (7) through the communication module.

5. The personalized pattern-based commodity virtual code assignment system according to claim 4, characterized by having at least one of the following features:
\textcircled{1} the parsing software parses the random personalized feature code (5) of each commodity (2) which is unique within the predetermined number based on the image transcoding coordinates (10) or/and feature unit transcoding grids (11) on the personalized feature image (20) when being executed by a processor; and the parsing device acquires the personalized feature code (5) according to the personalized feature pattern (4) or the image transcoding coordinates (10) or/and feature unit transcoding grids (11) on the scanned personalized feature image (20) when parsing the scanned personalized feature pattern (4);
\textcircled{2} the parsing software parses the random personalized feature code (5) of each commodity (2) which is unique within the predetermined number based on the feature unit transcoding grids (11) on the personalized feature image (20) when being executed by the processor, and different personalized features in the feature unit transcoding grids (11) are respectively expressed by different characters; and the parsing device acquires the personalized feature code (5) according to the feature unit transcoding grids (11) when parsing the scanned personalized feature pattern (4), and different personalized features in the feature unit transcoding grids (11) are respectively expressed by different characters.

6. The personalized pattern-based commodity virtual code assignment system according to claim 4, characterized by having at least one of the following features:
\textcircled{1} the parsing software conducts parsing for multiple times based on the personalized feature image (20) and the multiple predetermined parsing rules when being executed by a processor to obtain multiple random personalized feature codes (5) of each commodity (2) which are unique within the predetermined number; the parsing device acquires multiple personalized feature codes (5) according to the personalized, feature image (20) and the multiple predetermined parsing rules when parsing the scanned personalized feature pattern (4); and the retrieval device is used to retrieve multiple commodity codes (1) in the data memory based on multiple pieces of personalized feature information when the communication module receives the multiple pieces of personalized feature information, to compare the multiple commodity codes (1) to obtain the repeated commodity codes (1) and to send the repeated commodity codes (1) to the client (7) through the communication module;
\textcircled{2} the retrieval device is used to retrieve multiple commodity codes (1) in the data memory based on multiple pieces of personalized feature information when the communication module receives, the multiple pieces of personalized feature information, to compare the multiple commodity codes (1) to obtain the repeated commodity codes (1) and to send the repeated commodity codes (1) to the client (7) through the communication module;
\textcircled{3} the parsing software assigns grid lines of different widths to the same personalized feature image (20) when being executed by the processor, and parses multiple random personalized feature codes (5) of each commodity (2) which are unique within the predetermined number based on the personalized feature image (20) and the grid lines of different widths; the parsing device assigns grid lines of different widths to the same personalized feature pattern (4) or the scanned personalized feature image (20) when parsing the scanned personalized feature pattern (4), and parses multiple random personalized feature codes (5) of each commodity (2) which are unique within the predetermined number based on the grid lines of different widths; and the retrieval device is used to retrieve multiple commodity codes (1) in the data memory based on multiple pieces of personalized feature information when the communication module receives the multiple pieces of personalized feature information, to compare the multiple commodity codes (1) to obtain the repeated commodity codes (1) and to send the repeated commodity codes (1) to the client (7) through the communication module.
